(19) United States
(12) Patent Application Publication
(10) Pub. No.: US 2024/0048952 A1
(43) Pub. Date: Feb. 8, 2024

(54) Responder Dispatch Coordination System & Integrations

(71) Applicant: RapidSOS, Inc., New York, NY (US)

(72) Inventors: Daniel Seidberg, Manlius, NY (US); Gabriel Charles Mahoney, Brooklyn, NY (US); Michael Anthony Heneka, Fabius, NY (US); James Patrick Olejar, Fort Lauderdale, FL (US)

(21) Appl. No.: 18/230,424

(22) Filed: Aug. 4, 2023

Related U.S. Application Data
(60) Provisional application No. 63/370,617, filed on Aug. 5, 2022.
(60) Provisional application No. 63/466,927, filed on May 16, 2023.

(51) Int. Cl. H04W 4/90; H04W 4/029; H04M 1/72418

(52) U.S. Cl. CPC H04W 4/90; H04W 4/029; H04M 1/72418

(57) ABSTRACT

Disclosed herein is an emergency response data platform (ERDP) that facilitates data exchange between various data sources and various data recipients. Also disclosed herein is a responder dispatch coordination system (RDC) that facilitates communications between emergency service providers and first responders to aid emergency response networks and systems in responding to emergencies. Also disclosed herein are various ways in which ERDP and the RDC may be integrated to improve emergency response outcomes.

### CROSS-REFERENCE

This application claims the benefit of U.S. Provisional Application No. 63/370,617, filed Aug. 5, 2022, and U.S. Provisional Application No. 63/466,927, filed May 16, 2023, the contents of which are hereby incorporated herein by reference. All publications, patents, and patent applications mentioned in this specification are herein incorporated by reference to the same extent as if each individual publication, patent, or patent application was specifically and individually indicated to be incorporated by reference.

### BACKGROUND OF THE INVENTION

A person in an emergency situation may request help using a mobile communication device such as a cell phone to dial a designated emergency number like 9-1-1 or a direct access phone number for the local emergency service provider (e.g., an emergency dispatch center). Traditionally, this call is assigned to one or more first responders by the emergency service provider, and the caller's estimated location (generally either the location of a nearby cell tower or a triangulation from the location of three or more nearby cell towers) is provided to the emergency service provider by the caller's wireless carrier (e.g., AT&T). Alternatively, the caller may provide their location to the emergency service provider by verbally speaking their location over the phone. Unfortunately, many emergency callers are unaware of their precise location or otherwise unable to verbalize it.

However, modern technologies have enabled the development and implementation of previously unimaginable or unachievable emergency services. For example, modern communication devices are capable of generating highly accurate, real-time locations (e.g., device-based hybrid locations) during emergency situations (e.g., in response to an emergency number being dialed) and transmitting the locations to emergency management systems and emergency service providers. Emergency service providers can then use these accurate locations to more quickly locate and dispatch emergency assistance to emergency callers. In another example, devices such as surveillance cameras can capture images, videos, or audio that can be shared in real-time with emergency management systems and emergency service providers to provide emergency service providers with situational awareness that they did not have access to in the past. Similarly, modern technologies and communication devices allow for new ways of engaging with the on-the-ground first responders who respond to emergencies, such as firefighters and police officers. Digitally sharing emergency related data with first responders, and digitally receiving emergency related data from first responders, can make emergency response as a whole more effective and efficient.

### SUMMARY

In some aspects, disclosed herein is a system for providing emergency response assistance to first responders, the system comprising: (a) an emergency response data platform (ERDP) configured to receive an emergency alert comprising a user identifier and an emergency location associated with the user identifier; and (b) a responder dispatch coordination system (RDC) configured to: (i) receive, from an emergency service provider (ESP), a dispatch request comprising the user identifier; (ii) transmit, to the ERDP, an emergency data request comprising the user identifier; (iii) receive, from the ERDP, emergency data comprising the emergency location; and (iv) transmit, to a first responder application executed on a responder device, the emergency data comprising the emergency location for display within a graphical user interface (GUI) of the first responder application. In some embodiments, the emergency alert is associated with an emergency call routed to the ESP. In some embodiments, the emergency data further comprises personal data or medical data associated with user identifier. In some embodiments, the emergency data further comprises sensor data associated with the user identifier. In some embodiments, the ERDP comprises the RDC. In some embodiments, the ERDP is communicatively coupled to the RDC. In some embodiments, the RDC is further configured to extract the user identifier from the dispatch request. In some embodiments, the RDC is further configured to: (a) receive the dispatch request from the ESP in the form of an email; and (b) extract the user identifier from contents of the email. In some embodiments, the RDC is further configured to: (a) receive the dispatch request from the ESP in the form of an audio message over a radio signal; and (b) extract the user identifier from the audio message. In some embodiments, the RDC is further configured to record the audio message and provide access to the audio message to the responder device. In some embodiments, the RDC is further configured to provide access to the audio message to the responder device through the first responder application. In some embodiments, the ERDP is further configured to establish, between the ERDP and an emergency response application accessed on a computing device associated with the ESP, an emergency communication link. In some embodiments, the RDC is further configured to: (a) receive, from the first responder application, a selection of the dispatch request from within the GUI of the first responder application; (b) receive, from the first responder application, a responder identifier associated with the responder device and a responder location associated with the responder identifier; and (c) transmit, to the ERDP, the responder identifier and the responder location. In some embodiments, the responder location is generated by the responder device. In some embodiments, the ERDP is further configured to transmit, through the emergency communication link, the responder location to the ESP for display within a GUI of an emergency response application accessed on a computing device associated with the ESP. In some embodiments, the ERDP is further configured to provide the emergency response application to the ESP. In some embodiments, the ERDP provides the emergency response application to the ESP in the form of a website or a web application accessible via a standard web browser. In some embodiments, the emergency response application is not provided to the ESP by the ERDP. In some embodiments, the emergency response application is a computer aided dispatch (CAD) system. In some embodiments, the responder location is displayed within an interactive map within the GUI of the emergency response application. In some embodiments, the ERDP is further configured to transmit, through the emergency communication link, the emergency location to the ESP for display within the GUI of the emergency response application and wherein the emergency location and the responder location are displayed within the interactive map within the GUI of the emergency response application simultaneously. In some embodiments, the RDC is further configured to: (a) receive, from the first responder application, an updated responder location associated with the responder identifier; and (b) transmit, to the ERDP, the updated responder location. In some embodiments, the ERDP is further configured to transmit, through the emergency communication link, the updated responder location to the ESP for display within the interactive map within the GUI of the emergency response application. In some embodiments, the responder location and the updated responder location are displayed within the interactive map within the GUI of the emergency response application simultaneously. In some embodiments, the RDC is further configured to: (a) receive, from the first responder application, an audio or video recording; and (b) transmit, to the ERDP, the audio or video recording. In some embodiments, the ERDP is further configured to transmit, through the emergency communication link, the audio or video recording to the ESP for display within a GUI of an emergency response application accessed on a computing device associated with the ESP. In some embodiments, the audio or video recording is captured by the responder device. In some embodiments, the audio or video recording is streamed to the ESP through the emergency communication link. In some embodiments, the ERDP is further configured to: (a) receive an updated emergency location associated with the user identifier; and (b) transmit, to the RDC, the updated emergency location for transmission to and display within the GUI of the first responder application. In some embodiments, the emergency location and the updated emergency location are displayed within the GUI of the first responder application simultaneously. In some embodiments, RDC is further configured to provide the first responder application to the responder device. In some embodiments, the first responder application is not provided to the responder device by the RDC. In some embodiments, the ERDP is further configured to establish, between the first responder application and an emergency response application accessed on a computing device associated with the ESP, an emergency communication session. In some embodiments, the ERDP is further configured to facilitate, through the emergency communication session, an exchange of one or more text-based messages between the first responder application accessed on the responder device and the emergency response application accessed on the computing device associated with the ESP. In some embodiments, the ERDP is further configured to facilitate, through the emergency communication session, a voice call between the first responder application accessed on the responder device and the emergency response application accessed on the computing device associated with the ESP. In some embodiments, the voice call is a voice over internet protocol (VoIP) call. In some embodiments, the first responder application is further configured to transmit, through the emergency communication session, a responder location associated with the responder device for display within a GUI of the emergency response application. In some embodiments, the responder location is generated by the responder device. In some embodiments, the first responder application is further configured to transmit, through the emergency communication session, an updated responder location associated with the responder device for display within the GUI of the emergency response application. In some embodiments, the responder location and the updated responder location are displayed within the GUI of the emergency response application simultaneously. In some embodiments, the first responder application is further configured to transmit, through the emergency communication session, an audio or video recording for display within a GUI of the emergency response application. In some embodiments, the audio or video recording is generated by the responder device. In some embodiments, the audio or video recording is streamed from the responder device to the emergency response application through the emergency communication session.

In some aspects, disclosed herein is a method for providing emergency response assistance to first responders by a responder dispatch coordination system (RDC), the method comprising: (a) receiving, from an emergency service provider (ESP), a dispatch request comprising a user identifier; (b) transmitting, to an emergency response data platform (ERDP), an emergency data request comprising the user identifier; (c) receiving, from the ERDP, emergency data comprising an emergency location associated with the user identifier; and (d) transmitting, to a first responder application accessed on a responder device, the emergency data comprising the emergency location for display within a graphical user interface (GUI) of the first responder application. In some embodiments, the emergency location is displayed within an interactive map within the GUI of the first responder application. In some embodiments, the emergency data further comprises personal data or medical data associated with the user identifier. In some embodiments, the emergency data further comprises sensor data associated with the user identifier. In some embodiments, the method further comprises extracting the user identifier from the dispatch request. In some embodiments, the dispatch request is received in the form of an email and wherein the user identifier is extracted from contents of the email. In some embodiments, the dispatch request is received in the form of an audio message over a radio signal and wherein the user identifier is extracted from the audio message. In some embodiments, the method further comprises recording the audio message and providing access to the audio message to the responder device. In some embodiments, the method further comprises providing access to the audio message to the responder device through the first responder application. In some embodiments, the emergency location is received by the ERDP within an emergency alert associated with an emergency call routed to the ESP. In some embodiments, the ERDP comprises the RDC. In some embodiments, the RDC is communicatively coupled to the ERDP. In some embodiments, the method further comprises: (a) receiving, from the ERDP, an updated emergency location associated with the user identifier; and (b) transmitting, to the first responder application, the updated emergency location for display within the GUI of the first responder application. In some embodiments, the emergency location and the updated emergency location are displayed within an interactive map within the GUI of the first responder application simultaneously. In some embodiments, the method further comprises: (a) receiving, from the first responder application, a selection of the dispatch request from within the GUI of the first responder application; (b) receiving, from the first responder application, a responder identifier associated with the responder device and a responder location associated with the responder identifier; and (c) transmitting, to the ERDP, the responder identifier and the responder location for transmission to the ESP. In some embodiments, the responder location is generated by the responder device. In some embodiments, the method further comprises establishing, through the ERDP, an emergency communication session between the first responder application and an emergency response application accessed on computing device associated with the ESP. In some embodiments, the responder identifier and the responder location are transmitted to the ESP through the emergency communication session. In some embodiments, the responder location is displayed within an interactive map within a GUI of the emergency response application. In some embodiments, the method further comprises: (a) receiving, from the first responder application, an updated responder location associated with the responder identifier; and (b) transmitting, to the ERDP, the updated responder location for transmission to the ESP. In some embodiments, the updated responder location is transmitted to the ESP through the emergency communication session. In some embodiments, the updated responder location is displayed within the interactive map within the GUI of the emergency response application. In some embodiments, the responder location and the updated responder location are displayed within the GUI of the emergency response application simultaneously. In some embodiments, the method further comprises: (a) receiving, from the first responder application, an audio or video recording; and (b) transmitting, to the ERDP, the audio or video recording for transmission to the ESP. In some embodiments, the audio or video recording is transmitted to the ESP through the emergency communication session. In some embodiments, the audio or video recording is generated by the responder device. In some embodiments, the audio or video recording is streamed from the first responder application to the emergency response application through the emergency communication session. In some embodiments, the method further comprises facilitating, through the emergency communication session, an exchange of one or more text-based messages between the first responder application accessed on the responder device and the emergency response application accessed on the computing device associated with the ESP. In some embodiments, the method further comprises facilitating, through the emergency communication session, a voice call between the first responder application accessed on the responder device and the emergency response application accessed on the computing device associated with the ESP. In some embodiments, the voice call is a voice over internet protocol (VoIP) call. In some embodiments, the emergency response application is provided to the ESP by the ERDP. In some embodiments, the emergency response application is a website or a web application accessible via a standard web browser. In some embodiments, the emergency response application is not provided to the ESP by the ERDP. In some embodiments, the emergency response application is a computer aided dispatch (CAD) system. In some embodiments, the method further comprises providing the first responder application to the responder device. In some embodiments, the first responder application is not provided to the responder device by the RDC.

In some aspects, disclosed herein is non-transitory computer readable storage media comprising instructions that are executable by a processor to perform any of the methods disclosed herein. In some embodiments, the non-transitory computer readable storage media comprises instructions that are executable by a process to perform the method comprising: (a) receiving, from an emergency service provider (ESP), a dispatch request comprising a user identifier; (b) transmitting, to an emergency response data platform (ERDP), an emergency data request comprising the user identifier; (c) receiving, from the ERDP, emergency data comprising an emergency location associated with the user identifier; and (d) transmitting, to a first responder application accessed on a responder device, the emergency data comprising the emergency location for display within a graphical user interface (GUI) of the first responder application.

In some aspects, disclosed herein is a method for providing emergency response assistance to first responders by an emergency response data platform (ERDP), the method comprising: (a) receiving an emergency data request comprising a location of interest from a responder dispatch coordination system (RDC); (b) generating a geospatial boundary around the location of interest; (c) gathering emergency data associated with the locations within the geospatial boundary; and (d) transmitting the emergency data associated with locations within the geospatial boundary to the RDC for transmission to and display within a graphical user interface (GUI) of a first responder application. In some embodiments, the size and shape of the geospatial boundary are predetermined by the ERDP. In some embodiments, the size and shape of the geospatial boundary are dynamically determined by the ERDP after receiving the emergency data request. In some embodiments, the size and shape of the geospatial boundary are dynamically determined by the ERDP based at least in part on the location of interest. In some embodiments, the emergency data request is associated with a responder identifier and wherein the size and shape of the geospatial boundary are dynamically determined by the ERDP based at least in part on the responder identifier. In some embodiments, the emergency data request is generated in response to a selection made within the GUI of the first responder application. In some embodiments, the size and shape of the geospatial boundary are determined at least in part by a user of the first responder application through the GUI of the first responder application. In some embodiments, the emergency data request comprises a set of geospatial boundary parameters and wherein the size and shape of the geospatial boundary are determined at least in part on the set of geospatial boundary parameters. In some embodiments, the emergency data associated with locations within the geospatial boundary comprises one or more emergency response assets associated with asset locations within the geospatial boundary. In some embodiments, the emergency data associated with locations within the geospatial boundary comprises one or more responder locations within the geospatial boundary. In some embodiments, the emergency data associated with locations within the geospatial boundary comprises one or more responder identifiers associated with the one or more responder locations within the geospatial boundary. In some embodiments, the emergency data associated with locations within the geospatial boundary comprises one or more historical emergency locations within the geospatial boundary. In some embodiments, the emergency data associated with locations within the geospatial boundary comprises one or more user identifiers associated with the one or more historical emergency locations within the geospatial boundary.

In some aspects, disclosed herein is non-transitory computer readable storage media comprising instructions that are executable by a processor to perform any of the methods disclosed herein. In some embodiments, the non-transitory computer readable storage media comprises instructions that are executable by a process to perform the method comprising: (a) receiving an emergency data request comprising a location of interest from a responder dispatch coordination system (RDC); (b) generating a geospatial boundary around the location of interest; (c) gathering emergency data associated with the locations within the geospatial boundary; and (d) transmitting the emergency data associated with locations within the geospatial boundary to the RDC for transmission to and display within a graphical user interface (GUI) of a first responder application.

In some aspects, disclosed herein is a system for providing emergency response assistance to first responders, the system comprising: (a) an emergency response data platform (ERDP) configured to: (i) receive an emergency alert comprising a user identifier and an emergency location associated with the user identifier; and (ii) transmit, to a responder dispatch coordination system (RDC), the user identifier and the emergency location; and (b) the RDC, configured to: (i) receive, from the ERDP, the user identifier and the emergency location associated with the user identifier; (ii) transmit, to a first responder application accessed on a responder device, the user identifier and the emergency location associated with the user identifier for display within a graphical user interface (GUI) of the first responder application. In some embodiments, the GUI of the first responder application displays a list of dispatch requests and a list of emergency alerts and wherein user identifier is displayed within the list of emergency alerts. In some embodiments, the RDC is further configured to: (a) receive, after receiving the user identifier and the emergency location associated with the user identifier from the ERDP, a dispatch request comprising the user identifier; (b) transmit, to the first responder application, the dispatch request for display within the list of dispatch requests within the GUI of the first responder application; and (c) prompt the first responder application to remove the user identifier from the list of emergency alerts. In some embodiments, the RDC is further configured to provide the first responder application to the responder device. In some embodiments, the first responder application is not provided to the responder device by the RDC. In some embodiments, the ERDP is further configured to transmit the user identifier and the emergency location associated with the user identifier to the ESP through an emergency response application accessed on a computing device associated with the ESP. In some embodiments, the ERDP is further configured to provide the emergency response application to the ESP. In some embodiments, the emergency response application is a website or a web application accessible via a standard web browser. In some embodiments, the emergency response application is not provided to the ESP by the ERDP. In some embodiments, the emergency response application is a computer aided dispatch (CAD) system.

In some aspects, disclosed herein is a method for transmitting multimedia from a responder device to an emergency service provider (ESP), the method comprising: a) establishing, by a mobile application executed on a responder device, a first communication link with a multimedia capturing device through a wireless access point provided by the multimedia capturing device; b) establishing, by the mobile application, a second communication link with a multimedia processing server associated with an emergency response data platform (ERDP) through a cellular communication network; c) receiving, by the mobile application, through the first communication link, a stream of multimedia generated by the multimedia capturing device; d) transmitting, by the mobile application, through the second communication link, the stream of multimedia generated by the multimedia capturing device to the multimedia processing server associated with the ERDP for transmission to an ESP. In some embodiments, the wireless access point provided by the multimedia capturing device does not provide internet access. In some embodiments, the method further comprises establishing, by the mobile application, a third communication link with a channel bonding server associated with the ERDP through the cellular communication network, wherein the channel bonding server manages reception of the stream of multimedia from the multimedia capturing device to the mobile application through the first communication link and the transmission of the stream of multimedia from the mobile application to the multimedia processing server through the second communication link. In some embodiments, the method further comprises establishing, by the mobile application, a virtual private network (VPN) between the responder device and the channel bonding server, wherein the channel bonding server manages the reception of the stream of multimedia from the multimedia capturing device to the mobile application through the first communication link and the transmission of the stream of multimedia from the mobile application to the multimedia processing server through the second communication link through the VPN. In some embodiments, the channel bonding server associated with the ERDP is provided by the ERDP. In some embodiments, the channel bonding server associated with the ERDP is not provided by the ERDP. In some embodiments, the multimedia processing server associated with the ERDP is provided by the ERDP. In some embodiments, the multimedia processing server associated with the ERDP is not provided by the ERDP. In some embodiments, the mobile application receives the stream of multimedia from the multimedia capturing device in response to receiving a selection of a dispatch request from within a graphical user interface (GUI) of the mobile application. In some embodiments, the method further comprises receiving the dispatch request from the ESP. In some embodiments, the stream of multimedia is transmitted by the mobile application to the multimedia processing server through a first protocol and transmitted from the multimedia processing server to the ESP through a second protocol. In some embodiments, the first protocol is one of real-time streaming protocol (RTSP) and real-time messaging protocol (RTMP). In some embodiments, the second protocol is one of web real-time communication protocol (WebRTC) and HTTP live streaming protocol (HLS). In some embodiments, the stream of multimedia is transmitted by the multimedia capturing device to the mobile application through a first protocol and transmitted by the mobile application to the multimedia processing server through a second protocol. In some embodiments, the first protocol is RTSP and the second protocol is RTMP.

In some aspects, disclosed herein is a system for transmitting multimedia from a responder device to an emergency service provider (ESP), the system comprising: a) a multimedia capturing device, configured to: i) provide a wireless access point; ii) generate a stream of multimedia; and iii) transmit the stream of multimedia to a mobile application executed on a responder device; b) the mobile application, executed on the responder device and configured to: i) establish a first communication link with the multimedia capturing device through the wireless access point; ii) establish a second communication link with a multimedia processing server associated with an emergency response data platform (ERDP) through a cellular communication network; iii) receive, through the first communication link, the stream of multimedia from the multimedia capturing device; and iv) transmit, through the second communication link, the stream of multimedia to the multimedia processing server; and c) the multimedia processing server associated with the ERDP, configured to transmit the stream of multimedia to an ESP. In some embodiments, the wireless access point provided by the multimedia capturing device does not provide internet access. In some embodiments, the mobile application is further configured to establish a third communication link with a channel bonding server associated with the ERDP through the cellular communication network, wherein the channel bonding server manages reception of the stream of multimedia from the multimedia capturing device to the mobile application through the first communication link and the transmission of the stream of multimedia from the mobile application to the multimedia processing server through the second communication link. In some embodiments, the mobile application is further configured to establish a virtual private network (VPN) between the responder device and the channel bonding server, wherein the channel bonding server manages the reception of the stream of multimedia from the multimedia capturing device to the mobile application through the first communication link and the transmission of the stream of multimedia from the mobile application to the multimedia processing server through the second communication link through the VPN. In some embodiments, the channel bonding server associated with the ERDP is provided by the ERDP. In some embodiments, the channel bonding server associated with the ERDP is not provided by the ERDP. In some embodiments, the multimedia processing server associated with the ERDP is provided by the ERDP. In some embodiments, the multimedia processing server associated with the ERDP is not provided by the ERDP. In some embodiments, the mobile application is further configured to receive the stream of multimedia from the multimedia capturing device in response to receiving a selection of a dispatch request from within a graphical user interface (GUI) of the mobile application. In some embodiments, the mobile application is further configured to receive the dispatch request from the ESP. In some embodiments, the mobile application is further configured to transmit the stream of multimedia to the multimedia processing server through a first protocol and wherein the multimedia processing server is further configured to transmit the stream of multimedia to the ESP through a second protocol. In some embodiments, the first protocol is one of real-time streaming protocol (RTSP) and real-time messaging protocol (RTMP). In some embodiments, the second protocol is one of web real-time communication protocol (WebRTC) and HTTP live streaming protocol (HLS). In some embodiments, the multimedia capturing device is further configured to transmit the stream of multimedia to the mobile application through a first protocol and wherein the mobile application is further configured to transmit the stream of multimedia to the multimedia processing server through a second protocol. In some embodiments, the first protocol is RTSP and the second protocol is RTMP.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 depicts a diagram of an embodiment of an emergency response data platform (ERDP);

FIG. 2 illustrates an embodiment of a graphical user interface (GUI) provided by an emergency response application;

FIGS. 3A & 3B depict diagrams of embodiments of systems and processes for receiving and transmitting emergency data by an emergency response data platform;

FIG. 4 depicts a diagram of an ERDP in communication with one or more emergency alert sources, one or more monitoring center systems, and one or more emergency service providers;

FIGS. 5A, 5B, and 5C illustrate embodiments of a GUI provided by an emergency response application;

FIG. 6 depicts a diagram of an embodiment of a responder dispatch coordination system (RDC);

FIG. 7 depicts a diagram of an embodiment of an RDC in communication within one or more primary emergency service providers (ESPs), one or more secondary ESPs, and one or more first responders;

FIGS. 8A & 8B illustrate embodiments of a first responder application;

FIG. 9 illustrates an embodiment of a GUI provided by a secondary ESP application;

FIG. 10 illustrates an embodiment of a GUI provided by a primary ESP application;

FIGS. 11A & 11B depict embodiments of an RDC in communication with an ERDP;

FIG. 12 illustrates an embodiment of a GUI provided by a first responder application;

FIG. 13 illustrates an embodiment of a GUI provided by a first responder application;

FIG. 14 illustrates an example of a first responder responding to an emergency;

FIGS. 15A & 15B illustrate embodiments of a GUI provided by a first responder application;

FIG. 16 illustrates an embodiment of a GUI provided by an emergency response application;

FIG. 17 illustrates an embodiment of a GUI provided by an emergency response application;

FIG. 18 illustrates an embodiment of a GUI provided by an emergency response application; and

FIG. 19 depicts a diagram of an embodiment of a system for sharing multimedia captured by a first responder with an ESP.

### DETAILED DESCRIPTION

Disclosed herein are systems, devices, media, and methods for providing enhanced emergency communications and functions. Embodiments of the present disclosure take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls. Furthermore, mobile communication devices (e.g., mobile phones, wearables, IoT devices, smart home devices, vehicle computers, etc.) are often capable of generating or storing additional information that may be useful in responding to emergency situations, such as health data or medical histories. For example, during an emergency, a modern mobile communication device may have access to an implicated person's blood type, preexisting medical conditions, or even the implicated person's current heart rate. In some embodiments, the mobile communication device has access to data from sensors (e.g., health or environmental sensors). For example, a video feed of the emergency via a connected surveillance camera can provide valuable situational awareness regarding the emergency.

In one aspect, disclosed herein is an emergency response data platform (ERDP) capable of receiving emergency data (e.g., device-based hybrid locations and additional emergency information, such as health data, medical data, and multimedia) from smart devices and systems (e.g., mobile phones and IoT devices) and transmitting the emergency data to emergency service providers (ESPs) to assist the ESPs in responding to emergencies. However, while device-based hybrid locations are generally more accurate and more quickly generated than the locations estimated by wireless carriers (as mentioned above), device-based hybrid locations are generally only available for emergency calls made by mobile phones. Thus, because ESPs receive emergency calls from both mobile phone and landline phones, if the ERDP were to only provide device-based hybrid locations to an ESP, the ERDP would not be providing locations to the ESP for all of the emergency calls received by the ESP. There is therefore a desire for the ERDP to source and ingest locations associated with landline phones that make emergency calls to ESPs, so that the ERDP can provide locations to an ESP for all of the emergency calls that the ESP receives. In another aspect, then, disclosed herein is an ERDP capable of receiving emergency data from smart devices and systems and emergency call data (e.g., data associated with emergency calls made to ESPs) and transmitting both the emergency data and the emergency call data to the ESPs to assist the ESPs in responding to emergencies.

Emergency Response Data Platform

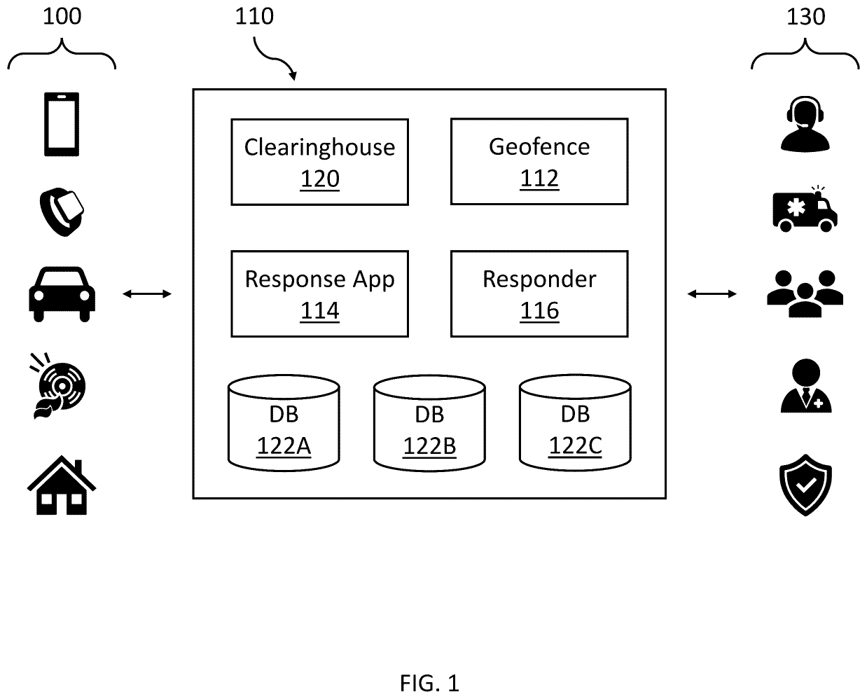

In various embodiments, disclosed herein are devices, systems, and methods for managing emergency data and emergency communications for more effective and efficient emergency response. FIG. 1 depicts a diagram of an emergency response data platform in accordance with one embodiment of the present disclosure. In a simple example, in some embodiments, an emergency data source 100 transmits information regarding an emergency (also referred to as “emergency data”) to an emergency response data platform (ERDP) 110 before, during, or after an emergency, and the emergency response data platform shares the emergency data with an emergency service provider (ESP) 130. The ESP 130 can then use the emergency data to more efficiently and effectively respond to corresponding emergencies. In some embodiments, the emergency data source 100 is a third-party server system (hereinafter, “third-party server”). For example, in some embodiments, the emergency data source 100 is a third-party server (e.g., a backend server system) of a technology company that produces software for electronic devices, such as Apple or Google. In some embodiments, the emergency data source 100 is an electronic device. For example, the emergency data source 100 may be a communication device (e.g., a walkie talkie or two-way radio, a mobile or cellular phone, a computer, a laptop, etc.), a wearable device (e.g., a smartwatch), or an Internet of Things (IoT) device such as a home assistant (e.g., an Amazon Echo) or a connected smoke detector (e.g., a Nest Protect smoke and carbon monoxide alarm). In some embodiments, an electronic device includes a display, a processor, a memory (e.g., an EPROM memory, a RAM, or a solid-state memory), a network component (e.g., an antenna and associated components, Wi-Fi adapters, Bluetooth adapters, etc.), a data storage, a user interface, an emergency alert program, one or more location components, and one or more sensors. In some embodiments, the processor is implemented as one or more microprocessors, microcomputers, microcontrollers, digital signal processors, central processing units, state machines, logic circuitries, and/or devices that manipulate signals based on operational instructions. Among other capabilities, the processor is configured to fetch and execute computer-readable instructions stored in the memory.

In some embodiments, the display is part of the user interface (e.g., a touchscreen is both a display and a user interface in that it provides an interface to receive user input or user interactions). In some embodiments, the user interface includes physical buttons such as an on/off button or volume buttons. In some embodiments, the display and/or the user interface comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage includes a location data cache and a user data cache. In some embodiments, the location data cache is configured to store locations generated by the one or more location components.

In some embodiments, the emergency alert program is a web application or mobile application. In some embodiments, the emergency alert program is configured to record user data, such as a name, address, or medical data of a user associated with the electronic device. In some embodiments, the emergency alert program is configured to detect when an emergency request is generated or sent by the electronic device (e.g., when a user uses the electronic device to make an emergency call). In some embodiments, in response to detecting an emergency request generated or sent by the electronic device, the emergency alert program is configured to deliver a notification to the ERDP 110. In some embodiments, the notification is an HTTP post containing information regarding the emergency request. In some embodiments, the notification includes a location (e.g., a device-based hybrid location) generated by or for the electronic device. In some embodiments, in response to detecting an emergency request generated or sent by the electronic device, the emergency alert program is configured to deliver user data to the ERDP 110.

In some embodiments, the emergency response data platform (ERDP) 110 includes an ERDP operating system, an ERDP CPU, an ERDP memory unit, an EMS communication element, and one or more software modules. In some embodiments, the ERDP CPU is implemented as one or more microprocessors, microcomputers, microcontrollers, digital signal processors, central processing units, state machines, logic circuitries, and/or devices that manipulate signals based on operational instructions. Among other capabilities, the ERDP CPU is configured to fetch and execute computer-readable instructions stored in the ERDP memory unit. The ERDP memory unit optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The ERDP memory unit optionally includes modules, routines, programs, objects, components, data structures, etc., which perform particular tasks or implement particular abstract data types.

In some embodiments, the ERDP 110 includes one or more ERDP databases, one or more servers, and a clearinghouse 120. In some embodiments, the clearinghouse 120, as described in further detail below, is an input/output (I/O) interface configured to manage communications and data transfers to and from the ERDP 110 and external systems and devices. In some embodiments, the clearinghouse 120 includes a variety of software and hardware interfaces, for example, a web interface, a graphical user interface (GUI), and the like. The clearinghouse 120 optionally enables the ERDP 110 to communicate with other computing devices, such as web servers and external data servers. In some embodiments, the clearinghouse 120 facilitates multiple communications within a wide variety of networks and protocol types, including wired networks, for example, LAN, cable, etc., and wireless networks, such as WLAN, cellular, or satellite. In some embodiments, the clearinghouse 120 includes one or more ports for connecting a number of devices to one another or to another server. In some embodiments, the clearinghouse 120 includes one or more sub-clearinghouses, such as location clearinghouse and additional data clearinghouse, configured to manage the transfer of locations and additional data, respectively. In some embodiments, the ERDP 110 additionally includes a user information module that receives and stores user information (e.g., personal information, demographic information, medical information, location information, etc.) within the ERDP 110. In some embodiments, users can submit user information through a website, web application, or mobile application, such as during a registration process for an emergency response application. In some embodiments, when the ERDP 110 receives emergency data including user information, such as through an emergency alert received by the clearinghouse 120 (as described below), the ERDP 110 stores the user information in the user information module. In some embodiments, user information stored within the user information module is received by the ERDP 110 from a third-party server system, as described above. In some embodiments, user information stored within the user information module is associated with an identifier of a user or an electronic device associated with a user, such as a phone number or an email address.

As mentioned above, in some embodiments, the emergency response data platform (ERDP) 110 shares emergency data with an emergency service provider (ESP) 130. In some embodiments, an ESP 130 (e.g., a public safety answering point (PSAP)) is a system that includes one or more of a display, a user interface, at least one central processing unit or processor, a network component, an audio system, (e.g., microphone, speaker and/or a call-taking headset), and an ESP application (e.g., a computer program) such as a computer aided dispatch (CAD) program or an emergency call taking program (also referred to as customer premise equipment or CPE). In some embodiments, the ESP application comprises a database of emergency responders, such as medical assets, police assets, fire response assets, rescue assets, safety assets, etc. In some embodiments, the ESP application is an emergency response application provided by the ERDP 110, as described below. In some embodiments, the ESP application is installed on a computing device at the ESP 130 and comprise one or more software modules, such as a call taking module, an ESP display module, a supplemental or updated information module, or a combination thereof. In some embodiments, the ESP application displays the information on a map (e.g., on the display). In some embodiments, the ESP application is accessible or executable on mobile devices associated with ESP 130, such as first responder devices. In some embodiments, the ESP application is an emergency response application provided by the ERDP 110, as described below.

In some embodiments, as depicted in FIG. 1, the ERDP 110 includes one or more modules, such as an emergency response application module 114 or a responder coordination module 116. In some embodiments, the ERDP 110 employs an emergency response application module 114 to provide an emergency response application to an ESP 130, as described below. In some embodiments, the ERDP 110 employs a responder coordination module 116 to execute or communicate with a responder dispatch coordination system (RDC), as described below.

Emergency Clearinghouse

In some embodiments, as mentioned above with respect to FIG. 1, the emergency response data platform (ERDP) 110 includes a clearinghouse 120 (also referred to as an “Emergency Clearinghouse”) for receiving, storing, retrieving, and transmitting emergency data. In some embodiments, as depicted by FIG. 1, through the clearinghouse 120, the ERDP 110 can receive emergency data from an emergency data source 100 (as described above) and transmit the emergency data to an emergency data recipient, such as an emergency service provider (ESP) 130 (as described above). In this way, the ERDP 110 acts as a data pipeline between emergency data sources 100 and ESPs 130. The emergency data that passes through the clearinghouse 120 may include (but is not limited to) location data (e.g., fixed addresses or device-based hybrid locations generated in real time) and additional data (e.g., medical history, personal information, or contact information, etc.). In some embodiments, through the clearinghouse 120, the ERDP 110 transmits emergency data to ESPs 130 to aid the ESPs 130 in responding to emergencies. For example, location data may allow emergency responders to arrive at the scene of an emergency faster, and additional data may allow emergency responders to be better prepared for the emergencies that they face.

The clearinghouse 120 may receive emergency data in various ways. For example, in some embodiments, an emergency data source 100 can unilaterally transmit emergency data to the clearinghouse 120. For example, in one embodiment, an emergency alert is triggered by an electronic device manually (e.g., in response to the selection of a soft or hard emergency button) or automatically based on sensor data received by the electronic device (e.g., smoke alarms). The electronic device can then transmit the emergency alert and any associated data to the ERDP 110, such as to an endpoint provided by the clearinghouse 120. Or, for example, in one embodiment, after an emergency alert is received by the ERDP 110 from a first emergency data source, the ERDP 110 can query a second emergency data source for emergency data (e.g., emergency data associated with the emergency alert received from the first emergency data source). For example, the emergency alert received from the first emergency data source may include a user identifier (e.g., a telephone number or an email address) for an owner or user of the first emergency data source. The ERDP 110 can then query the second emergency data source with the user identifier to retrieve additional emergency data associated with the owner or user of the first emergency data source. In some embodiments, emergency data received by the ERDP 110 is received in a format that is compatible with industry standards for storing and sharing emergency data. In some embodiments, the ERDP 110 formats emergency data that it receives into a format that is compatible with industry standards. For example, in some embodiments, the emergency data is formatted to be compatible with National Emergency Number Association (NENA) standards. In some embodiments, emergency data is formatted by the ERDP 110 to be compliant with the Presence Information Data Format Location Object (PIDF-LO) standard. In some embodiments, emergency data (or emergency call data, as described below) is formatted by the ERDP to be compliant with the Emergency Incident Data Object (EIDO) standard. In some embodiments, emergency data received by the ERDP 110 is stored within one or more databases 122. In some embodiments, emergency data received by the ERDP 110 is associated with one or more identifiers, such as a device or user identifier.

The clearinghouse 120 may share emergency data in various ways. For example, in some embodiments, an emergency data recipient, such as an ESP 130, can query the ERDP 110 for emergency data. For example, in some embodiments, an ESP 130 can query the ERDP 110 with an emergency data request including a user identifier (e.g., a telephone number or an email address) to receive emergency data gathered or received by the ERDP 110 associated with the user identifier. Or for example, in some embodiments, an ESP 130 can query the ERDP 110 with a geospatial area to receive emergency data gathered or received by the ERDP 110 associated with the geospatial area. Alternatively, in some embodiments, the ERDP 110 can autonomously transmit emergency data to an emergency data recipient without first receiving a query from the emergency data recipient (also referred to as “pushing” emergency data, as opposed to emergency data being “pulled” with a query). In some embodiments, the ERDP 110 pushes emergency data to an emergency data recipient using an emergency data subscription system. Using the emergency data subscription system, an emergency data recipient can subscribe to the clearinghouse 120 for a particular device identifier, user identifier, ESP account, or geospatial area. After subscribing to a subscription, the emergency data recipient may automatically receive updates regarding the subscription without first sending a query for emergency data. For example, if an ESP 130 subscribes to a phone number, whenever the ERDP 110 receives updated emergency data associated with the phone number, the clearinghouse 120 can instantly and automatically transmit the updated emergency data associated with the phone number to the ESP 130.

Emergency Data Geofencing

In some embodiments, a geofence system 112 is applied to the clearinghouse 120 or the ERDP 110 to protect sensitive emergency data from being shared with unintended recipients. As depicted in FIG. 1, in some embodiments, when emergency data (e.g., an emergency location or additional data) is received by the ERDP 110 from an emergency data source 100, the emergency data is first processed by the geofence system 112 before being ingested by the clearinghouse 120. Similarly, in some embodiments, when a query for emergency data is received by the ERDP 110 from an emergency data recipient (e.g., an ESP 130), the query is processed by the geofence system 112 before emergency data is transmitted to the emergency data recipient.

Generally, a geofence is a virtual perimeter that represents a real-world geographic area. A geofence can be dynamically generated—as in a radius around a point location—or a geofence can be a predefined set of boundaries (such as school zones or neighborhood boundaries). For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

In some embodiments, the ERDP 110 maintains a geofence database including one or more geofences associated with each ESP 130 that is or has ever been communicatively coupled to the ERDP 110. In some embodiments, a geofence associated with an ESP 130 may be submitted to the ERDP 110 by an administrator of the ESP 130, such as through an emergency response application (as described below) or via email. In some embodiments, when emergency data is received by the ERDP 110 the ERDP 110 identifies a location associated with the emergency data (e.g., an emergency location included in an emergency alert) and determines if the location is within the combined authoritative jurisdiction (i.e., within any one of the geofences stored in the geofence database). In some embodiments, if the location is not within the combined authoritative jurisdiction, the ERDP 110 rejects or drops the emergency data (also referred to as “ingress filtering”). In some embodiments, when the ERDP 110 receives a query for emergency data from an ESP 130, the ERDP 110 identifies a geofence associated with the ESP 130 and returns only emergency data associated with locations that are within the geofence associated with the ESP 130 (also referred to as “egress filtering). In some embodiments, geofences are used in routing emergency data that is pushed to an emergency data recipient. In some embodiments, example, as mentioned above, an emergency data recipient may subscribe to a geofence. Then, when the ERDP 110 receives emergency data associated with a location that is within the geofence to which the emergency data recipient has subscribed, the ERDP 110 can instantly and automatically push the emergency data to the emergency data recipient.

Emergency Response Application

As mentioned above, in some embodiments, data and information is shared between the emergency response data platform (ERDP) and an emergency service provider (ESP) through an emergency response application. In some embodiments, as described in further detail below, the emergency response application may additionally be provided to an ESP to: a) facilitate communications between the ESP and an emergency caller (e.g., a person requesting emergency assistance) or b) facilitate communications between the ESP and one or more other ESPs. In some embodiments, the emergency response application is a software application either installed on a computing device at the ESP or accessed via the internet through a web browser on the computing device (e.g., the emergency response application is hosted on a cloud computing system by the ERDP). In some embodiments, the emergency response application functions to both facilitate a two-way communication link between the ERDP and the ESP and visualize data (e.g., emergency data) received by the ESP from the ERDP. The emergency response application optionally includes various components, such as a front-end application (hereinafter “graphical user interface” or “GUI”), a backend application, an authorization module, and a user database. In some embodiments, the emergency response application additionally or alternatively includes a credential management system or a geofence system (which may include or be otherwise communicatively coupled to a credentials database or a geofence database). In some embodiments, the credential management system and the geofence system are external to the emergency response application and communicatively coupled to the emergency response application (e.g., the credential management system or geofence system can be housed or hosted on a cloud computing system by the ERDP). Any or all of the components of the emergency response application may be hosted on a cloud computing system by the ERDP, a computing device at an ESP, or some combination thereof.

In some embodiments, the emergency response application is a webpage or web application that can be accessed through an internet or web browser. In such embodiments, the emergency response application can be quickly and easily integrated into the systems used by emergency service providers (ESPs), such as public safety answering points (PSAPs), because accessing and using emergency response application requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. In some embodiments, the clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application to PSAPs in the form of a webpage accessible through a standard web browser, in order to provide the potentially life-saving information stored within the clearinghouse to those capable of providing emergency assistance as quickly and easily as possible. However, in some embodiments, the emergency response application is a software application installed on a computing device at an ESP. The emergency response application may be provided by the ERDP or by a third-party.

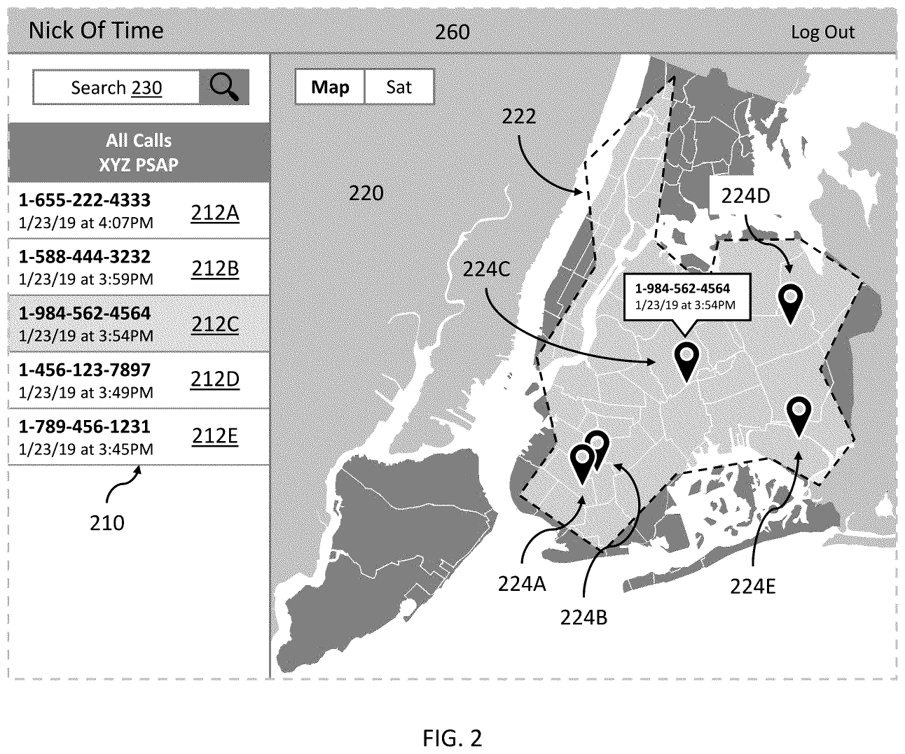

FIG. 2 illustrates an embodiment of a graphical user interface (GUI) provided by an emergency response application 260. In some embodiments, the GUI provides interactive elements that allow a user at an ESP to receive data from the ERDP, visualize data received from the ERDP, and transmit data to the ERDP. For example, in some embodiments, the GUI includes an entry field 230 through which a user can submit a device identifier, such as by typing or pasting the device identifier into the entry field 230. In some embodiments, after submitting a device identifier through entry field 230, the user can prompt the emergency response application to generate and send an emergency data request by selecting a search button. The emergency response application 260 then generates an emergency data request including the device identifier and any other necessary information (e.g., a temporary access token) and transmits the emergency data request to the ERDP. The ERDP can then return any available emergency data associated with the device identifier to the emergency response application 260, as described above and below. In another example, in some embodiments, the emergency response application 260 can automatically receive emergency data from the ERDP for emergencies relevant to an ESP (e.g., emergencies located within the jurisdiction of the ESP) without requiring a user to generate an emergency data request, as described above and below. After receiving emergency data from the ERDP, the emergency response application 260 can then visualize the emergency data within the GUI of the emergency response application 260. For example, in some embodiments, the emergency response application 260 includes a list of incidents 210 and an interactive map 220, as illustrated by FIG. 2. As shown, in some embodiments, when the emergency response application 260 receives a location (e.g., an emergency location) and a device identifier associated with an emergency occurring within the jurisdiction 222 of the receiving ESP, the emergency response application 260 displays the location associated with the emergency within the interactive map 220 as a location marker 224 (also referred to as an “incident location”) and displays the device identifier associated with the emergency within the list of incidents 210 as an incident 212.

In addition to emergency locations, the emergency response application 260 can receive and visualize numerous types of emergency data from the ERDP. For example, the emergency response application 260 can receive additional data regarding an emergency, such as demographic or medical data associated with a person involved in the emergency (e.g., an emergency caller). In another example, the emergency response application 260 can receive data from sensors associated with the emergency, such as heartrate data collected by a sensor on an emergency caller's smartwatch. Or, for example, the emergency response application 260 can receive data regarding emergency response assets available for an emergency, as described below. In some embodiments, the emergency response application receives and visualizes messages received from emergency callers or other ESPs, as described below. The emergency response application 260 can visualize any emergency data received from the ERDP within the GUI of the emergency response application.

Emergency Data Transmission

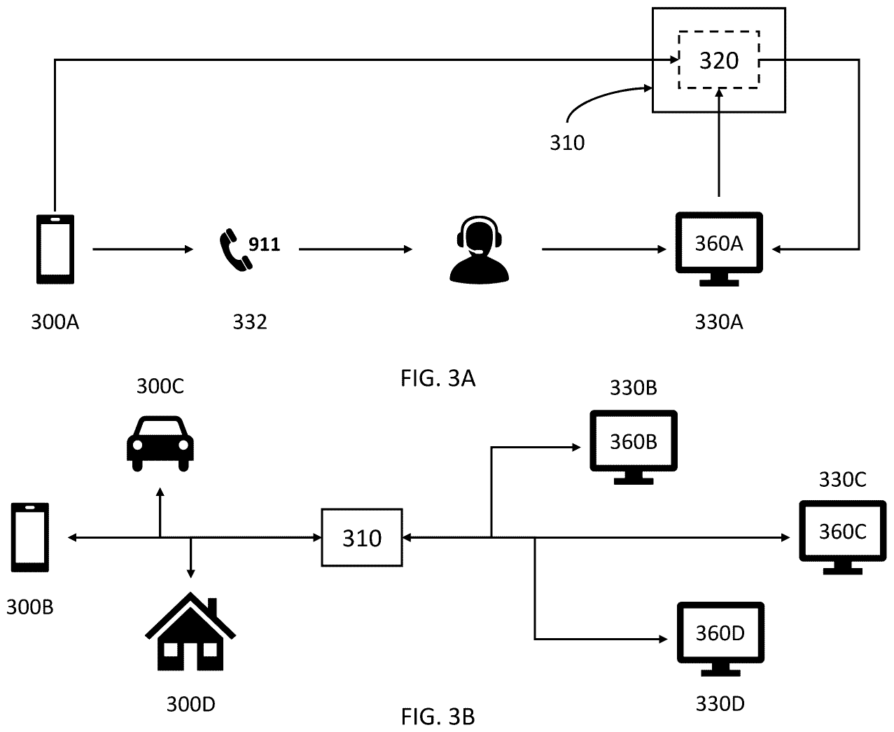

FIGS. 3A and 3B depict systems and processes for receiving and transmitting emergency data by an emergency response data platform in accordance with some embodiments of the present disclosure. As described above, in some embodiments, an emergency response data platform (ERDP) maintains a clearinghouse that obtains and shares emergency data to aid emergency service providers (ESPs) in responding to emergencies. For example, as depicted in FIG. 3A, during an emergency, an ESP 330A can send a query for emergency data (also referred to as an “emergency data request”) to the ERDP 310 (e.g., through an emergency response application 360A, as described above) for a particular emergency, and, in response, the ERDP 310 can send any available emergency data associated with the emergency back to the ESP 330A (such as through emergency response application 360A). In some embodiments, as described above, the emergency response application 360A includes an identifier associated with an emergency alert in the emergency data request. The ERDP 310 can then use the identifier associated with the emergency alert to retrieve emergency data associated with the emergency alert from the clearinghouse 320. For example, as described above, an ESP 330A (e.g., a public safety answering point (PSAP)) can receive an emergency alert in the form of a 9-1-1 phone call 332 (representative of an emergency or potential emergency) from a mobile phone 300A associated with a phone number (e.g., (555) 555-5555). The ESP 330A can then send an emergency data request including the phone number (i.e., the identifier associated with the emergency alert) to the ERDP 310, which can then retrieve any emergency data within the clearinghouse 320 associated with the phone number and return the available emergency data to the requesting ESP 330A. This process of returning emergency data to an ESP in response to an emergency data request is referred to as “pulling” emergency data from the clearinghouse.

As described above, in some embodiments, the emergency response data platform (ERDP) can “push” emergency data from the Emergency Clearinghouse to emergency service providers (ESPs), such as by using an emergency data subscription system (hereinafter, “subscription system”). FIG. 3B depicts a flow diagram of a process for pushing emergency data from the Emergency Clearinghouse to one or more ESPs. In some embodiments, a member of an ESP (e.g., a PSAP staff member) logs into the emergency response application 360B at an ESP system 330B (e.g., a computing device associated with the ESP) by accessing the emergency response application 360B (e.g., by navigating to the emergency response application 360B through a web browser) and submitting their login information through the GUI of the emergency response application 360B. In some embodiments, when the ESP member logs into the emergency response application 360B by submitting their login information, the emergency response application 360B or ERDP 310 then determines an ESP account ID associated with the ESP member's account and establishes a persistent or active communication link (e.g., a websocket connection) with the ESP system 330B, thereby automatically subscribing the ESP console to the ESP account ID for the duration of their login session. Then, as described above, when the ERDP 310 receives an emergency alert including a location (e.g., when an emergency call is made from an electronic device 300B and sends an emergency alert to the ERDP 310 including a location generated by the electronic device 300B), the ERDP 310 retrieves a geofence associated with every ESP registered with the ERDP 310 and determines if the location falls within any of the geofences. In response to determining that the location falls within a geofence associated with the ESP associated with the ESP account ID, the ERDP 310 then associates the location with the ESP account ID, determines if there are any active or persistent communication links between the ERDP 310 and any computing devices subscribed to the ESP account ID. In this instance, because the ESP system 330B is subscribed to the ESP account ID and actively linked to the ERDP 310 through the persistent or active communication link, the ERDP 310 automatically pushes (e.g., from the clearinghouse) the emergency alert or emergency data associated with the emergency alert (e.g., the location, a phone number, etc.) to the ESP system 330B for display within the emergency response application 360B. In some embodiments, emergency alerts or emergency data associated with emergency alerts that have been pushed to an ESP are displayed within a jurisdictional awareness view, as described below.

For example, ESP system 330B and ESP system 330C are two different ESP consoles associated with the same ESP (e.g., two computing devices at the same public safety answering point (PSAP)), PSAP A. ESP system 330D is associated with a second ESP, PSAP B. One day, PSAP call-takers access and successfully log into the emergency response application 360 (emergency response application 360D-360D) at each of the three ESP system (ESP systems 330B-330D), thereby establishing three separate active communication links, one active communication link between the ERDP 310 and each of the three ESP consoles. The ESP consoles are automatically subscribed by the ERDP 310 to the ESP account IDs associated with their respective ESPs (ESP ID A for PSAP A and ESP ID B for PSAP B). Both PSAP A and PSAP B are associated with only one geofence, geofence A and geofence B, respectively. Geofences A and B do not overlap. The geofences have previously been tagged within the ERDP 310 with their respective ESP account IDs (e.g., during a registration process for the emergency response application).

Later that day, an emergency call is made from communication device 300B, which causes communication device 300B to generate a first emergency alert including a first location of the communication device 300B and transmit the first emergency alert to the ERDP 310. When the ERDP 310 receives the first emergency alert, the ERDP 310 retrieves some or all of the geofences stored within the ERDP 310 and determines if the first location falls within any of the geofences stored within the ERDP 310. In this example, the ERDP 310 determines that the first location falls within geofence A, associated with PSAP A. In response, the ERDP 310 tags the first location with the ESP account ID associated with geofence A, ESP ID A. The ERDP 310 then determines if there are any active communication links between the ERDP and any ESP consoles subscribed to ESP ID A and automatically pushes (e.g., from the clearinghouse) the first emergency alert to those ESP consoles. In this example, both ESP system 330B and ESP system 330C are subscribed to ESP ID A, so the ERDP 310 automatically pushes the first emergency alert to both ESP system 330B and ESP system 330C for display within emergency response applications 360B and 360C, respectively, such as through a jurisdictional awareness view (as described below). The first location does not fall within geofence B, because geofence A and geofence B do not overlap, so the first emergency alert is not pushed to ESP system 330D, even though an active communication link has been established between the ERDP 310 and ESP system 330D.

Three minutes later, the ERDP 310 receives an emergency alert from electronic device 300D (e.g., a home security system) including a second location of the electronic device 300D. When the ERDP 310 receives the second emergency alert, the ERDP again retrieves some or all of the geofences stored within the ERDP 310 and determines if the second location falls within any of the geofences stored within the ERDP 310. In this example, the ERDP 310 determines that the second location falls within geofence B, associated with PSAP B. In response, the ERDP 310 tags the second location within the ESP account associated with geofence B, ESP ID B and automatically pushes the second emergency alert to ESP system 330D for display within emergency response application 360D, because ESP system 330D has an active communication link established with the ERDP 310 and ESP system 330D is subscribed to ESP ID B. The ERDP 310 does not push the second emergency alert to ESP system 330B or ESP system 330C. Although ESP system 330B and ESP system 330C have active communication links established with the ERDP 310, they are not subscribed to ESP ID B, and geofence A and geofence B do not overlap, meaning the second location does not fall within geofence A. Two minutes after that, the ERDP 310 receives an emergency alert from electronic device 300C (e.g., an intelligent vehicle system) including a third location of the electronic device 300C. The ERDP 310 determines that the third location falls within geofence A (like the first location included in the first emergency alert) and thus automatically pushes the third emergency alert to both ESP system 330B and ESP system 330C for display within emergency response application 360B and 360C. In some embodiments, emergency response application 360B and emergency response application 360C display the first emergency alert and the third emergency alert simultaneously, such as through a jurisdictional awareness view, as described below.

Jurisdictional Awareness View

In some embodiments, the systems, applications, servers, devices, methods, and media of the instant application provide a jurisdictional awareness view within the emergency response application. In some embodiments, the jurisdictional awareness view enables an ESP to view one or more ongoing or recently received emergency alerts (e.g., emergency calls) within one or more geofenced jurisdictions. FIG. 2 illustrates the jurisdictional awareness view displayed within the emergency response application, in accordance with one embodiment of the present disclosure. In some embodiments, the jurisdictional awareness view includes a list of incidents 210 that displays one or more incidents 212 associated with one or more device identifiers (e.g., phone numbers, IP addresses). In some embodiments, the jurisdictional awareness view additionally or alternatively includes an interactive map 220 that displays one or more incident locations 224 associated with the one or more incidents 212 associated with the one or more device identifiers, as described below. In some embodiments, the jurisdictional awareness view displays incidents and incident locations only for emergencies occurring within the jurisdiction 222 of the ESP at which the emergency response application 260 is being accessed.

For example, in the example illustrated in FIG. 2, an ESP has accessed an emergency response application 260 provided by the ERDP. In this example, the ERDP has pushed emergency data associated with five different emergency alerts to the ESP (as described above) through the emergency response application 260. Accordingly, the emergency response application 260 displays five different incidents 212 (e.g., incidents 212A-212E) within the list of incidents 210 and five corresponding incident locations 224 (e.g., incident locations 224A-224E) within the interactive map 220. As illustrated by FIG. 2, in some embodiments, incidents 212 and incident locations 224 may be selected or hovered over to highlight a particular incident 212. In this example, incident 212C and its corresponding incident location 224C have been selected and highlighted. In some embodiments, selecting a particular incident 212 or corresponding incident location 224 prompts the emergency response application 260 to display additional information associated with the particular incident 212 (e.g., additional emergency data or information associated with the emergency alert for which the particular incident 212 was created). Because the jurisdictional awareness view can show an ESP numerous incidents 212 occurring within the jurisdiction 222 of the ESP simultaneously, the jurisdictional awareness view can provide the ESP with situational awareness that the ESP otherwise would not have. For example, with the knowledge that incidents 212A and 212B originated in close proximity and at approximately the same time, an ESP personnel (e.g., a call taker at a public safety answering point) can determine that the two incidents may be related.

Digital Emergency Service Requests

In some embodiments, the ERDP can facilitate the transmission of a digital request for emergency service (also referred to as a “digital primary request for emergency service” or a “digital emergency service request”) to an emergency service provider (ESP). As mentioned above, typically, a person experiencing an emergency may only submit a primary request for emergency service (also referred to as a “primary emergency service request” or an “emergency service request”) to an emergency service provider (e.g., a public safety answering point (PSAP)) verbally, such as by dialing 9-1-1 in the United States and verbally articulating the details of their emergency over a phone call. This process takes time away from providing emergency response, is prone to human error, and requires that the person is physically able to verbally articulate the details of their emergency, which is far from a given. Even in the case of a home security alarm, for example, the alarm is typically sent to a monitoring center where a call-taker at the monitoring center must call an emergency service provider and verbally articulate the details of the potential emergency. Provided herein are systems and methods for delivering digital emergency service requests to emergency service providers. By delivering digital emergency service requests to emergency service providers, as opposed to verbally delivering emergency service requests (e.g., emergency phone calls), significant time can be saved in providing emergency response, human error can be eliminated, and people who are not able (physically, such as when a person has fallen unconscious, or otherwise, such as when a person is kidnapped and fearing for their life) to verbally articulate the details of their emergency may still submit an emergency service request to an emergency service provider. Traditional emergency service requests (e.g., emergency calls) can and typically must be serviced by an emergency service provider (e.g., a call-taker at a PSAP can and typically must answer an emergency call received by the PSAP). Similarly, a digital emergency service request must provide an emergency service provider with one or more options for servicing (e.g., the ability to be claimed or ignored, as described below).

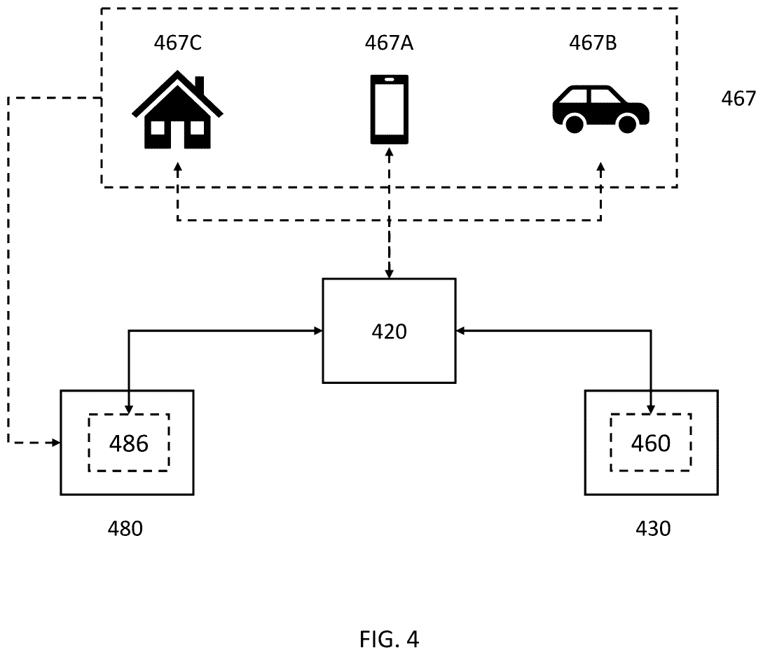

For example, as depicted in FIG. 4, in some embodiments, when an emergency alert is generated by an alert source 467 (e.g., mobile phone 467A, intelligent vehicle system 467B, or home security system 467C), the emergency alert is transmitted (e.g., by a private security system associated with the alert source, as described below) to either or both of a monitoring center system 480 (as described below) and an emergency response data platform (ERDP) 420. In some embodiments, the emergency alert is first received by an alert aggregator (not shown; also referred to as a “receiver” or an “alarm receiver”) before being transmitted to a monitoring center system 480 or the ERDP 420. In some embodiments, when an emergency alert is generated by an alert source 467, the emergency alert is transmitted (e.g., by the alert source, or by a private security system associated with the alert source) only to a monitoring center system 480. In some embodiments, when an emergency alert is generated by an alert source 467, the emergency alert is transmitted only to the ERDP 420. In some embodiments, when an emergency alert is generated by an alert source 467, the emergency alert is transmitted to a monitoring center system 480 and the ERDP 420 in parallel. In some embodiments, after receiving the emergency alert, a monitoring center system 480 (e.g., a call-taker associated with the monitoring center system) can select to transmit the emergency alert, and any emergency data associated with the emergency alert, to the ERDP 420 (e.g., by selecting a “Push to PSAP” button within a graphical user interface of an alarm handling software application or a monitoring center portal 486). In some embodiments, after receiving an emergency alert, a monitoring center system 480 verifies the emergency alert (e.g., by contacting a user associated with the alert source 467 that generated the emergency alert to confirm the emergency) before transmitting the emergency alert to the ERDP 420. In some embodiments, after receiving the emergency alert (e.g., from a monitoring center system 480 or a private security system associated with the alert source that generated the emergency alert), the ERDP 420 generates and transmits a digital emergency service request associated with the emergency alert to an ESP 430. In some embodiments, when the ERDP 420 receives an emergency alert, the ERDP 420 does not generate or transmit a digital emergency service request associated with the emergency alert to an ESP 430 until the ERDP 420 receives a request to generate and transmit a digital emergency service request associated with the emergency alert to an ESP 430 from a monitoring center system 480 that also received the emergency alert (e.g., after a call-taker associated with the monitoring center system selects a “Push to PSAP” button within a graphical user interface of an alarm handling software application or a monitoring center portal).

In some embodiments, when the ERDP 420 generates and transmits a digital emergency service request associated with an emergency alert to an ESP 430, the ERDP 420 determines an appropriate ESP 430 to receive the digital emergency service request using a location associated with the emergency alert. For example, in some embodiments, the emergency alert includes a location associated with the emergency alert (e.g., a location generated by the alert source 467 that generated the emergency alert), and the ERDP 420 determines an appropriate ESP 430 to receive the digital emergency service request associated with the emergency alert using a geofencing system, as described above. For example, using a geofence system, the ERDP 420 gathers geofences associated with ESPs 430 and determines if the location associated with the emergency alert falls within any of the geofences. After determining that the location associated with the emergency alert falls within a geofence associated with a particular ESP 430, the ERDP 420 then determines if there are any active or persistent communication links established between the ERDP 420 and the ESP 430. If so, the ERDP 420 can automatically generate and transmit a digital emergency service request associated with the emergency alert to the ESP 430 through the active or persistent communication link established between the ERDP 420 and the ESP 430. In some embodiments, when the ERDP 420 generates and transmits a digital emergency service request, the ERDP 420 determines an appropriate ESP 430 to receive the digital emergency service request using additional data alternatively or in addition to a location associated with the emergency alert, such as the type of alert (e.g., an emergency type) or the alert source. For example, in some embodiments, if an emergency alert is generated by a home security system (e.g., the home security system detects a break in through a window), the ERDP 420 can generate a digital emergency service request and transmit the digital emergency service request directly to a police department based on the type of the emergency alert being a home security alarm. In another example, in some embodiments, if an emergency alert is generated by a smoke detector, the ERDP 420 can generate a digital emergency service request and transmit the digital emergency service request directly to a fire department based on the source of the emergency alert being a smoke detector. However, the ERDP 420 may determine an appropriate ESP 430 to receive a digital emergency service request based on any other factor.

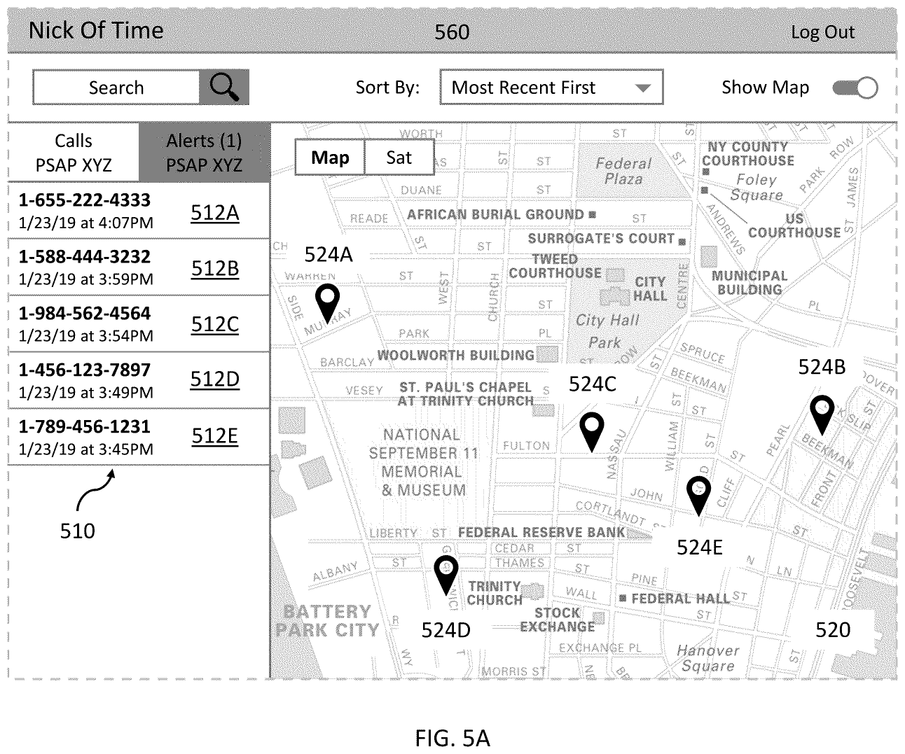

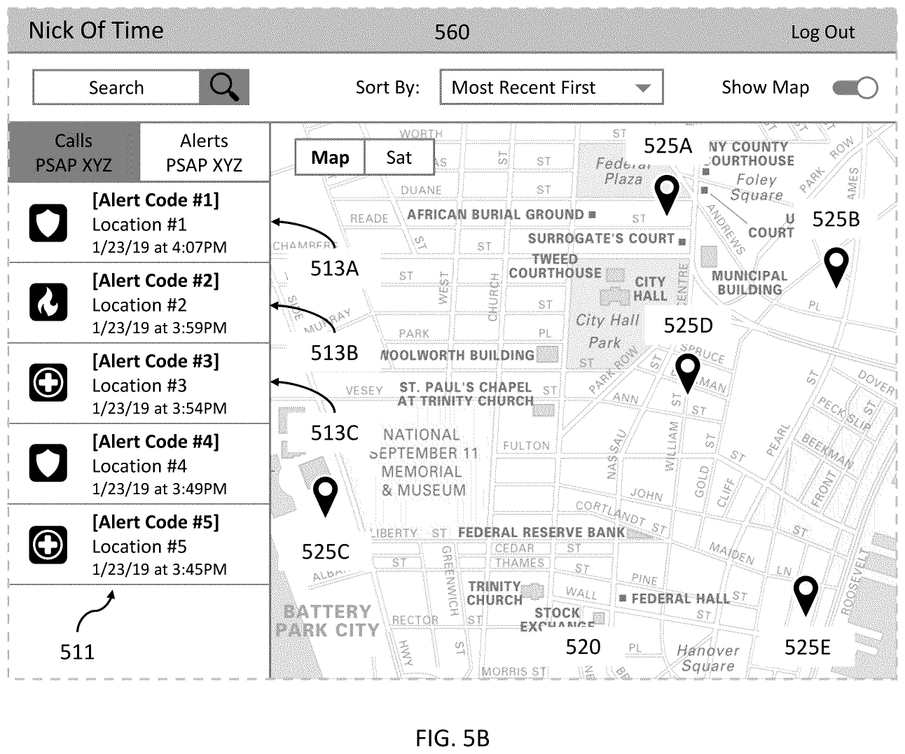

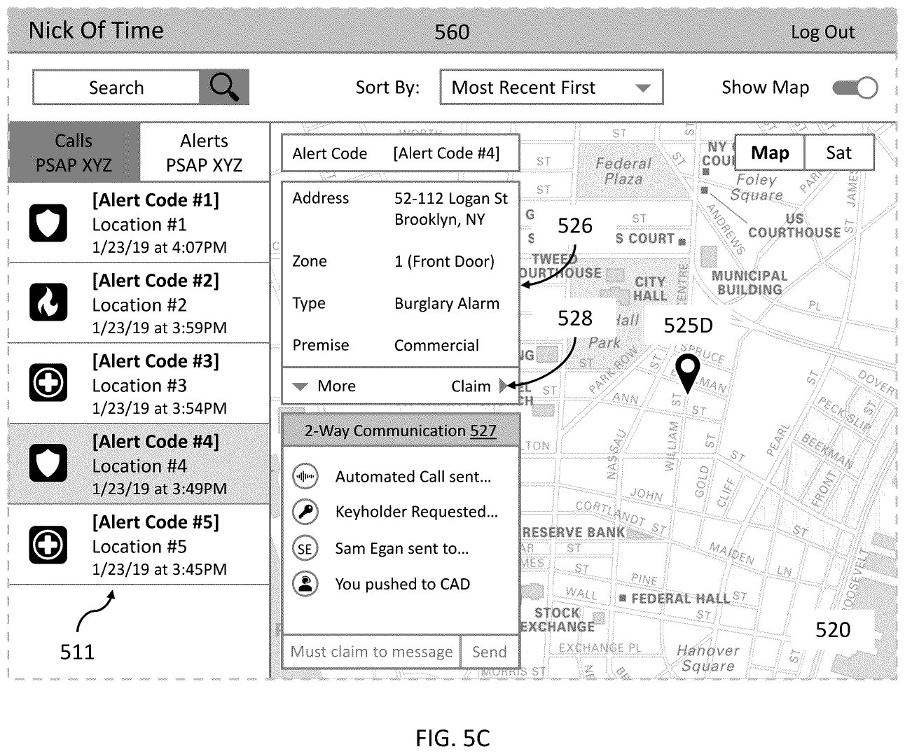

In some embodiments, the emergency response data platform (ERDP) is integrated into existing systems within an emergency service provider (ESP), such as a call handling software application or computer aided dispatch (CAD) system. In some such embodiments, the ERDP can transmit a digital emergency service request to an ESP through the integrations with the existing systems within the ESP. In some embodiments, the ERDP provides an emergency response application 460 to ESPs through which the ERDP can transmit digital emergency service requests, as depicted in FIGS. 5A-5C. As described above, in various embodiments, an emergency response application provided to an ESP by the ERDP includes a graphical user interface (GUI) that includes a list of incidents (also referred to as an “incident queue”) and an interactive map. For example, in some embodiments, as illustrated in FIG. 5A, the list of incidents 510 includes one or more incidents 512 (e.g., incidents 512A-512E), and the interactive map 520 includes one or more incident locations 524 (e.g., incident locations 524A-524E) associated with one or more incidents 512 included in the list of incidents 510. In some embodiments, as illustrated in FIG. 5B, the emergency response application 560 includes a list of digital emergency service requests 511 (also referred to as an “alerts queue”). For example, in some embodiments, as illustrated in FIGS. 5A-5C, the emergency response application 560 includes both a list of incidents and a list of digital emergency service requests, and a user of the emergency response application can choose between the list of incidents and the list of digital emergency service requests by selecting an incidents tab (e.g., the Calls tab, as illustrated in FIG. or a digital emergency service requests tab (e.g., the Alerts tab, as illustrated in FIG. 5B). In some embodiments, as illustrated in FIG. 5A, the digital emergency service requests tab displays the number of digital emergency service requests transmitted to an ESP through the emergency response application from the ERDP since the list of digital emergency service requests was last displayed within the GUI of the emergency response application. Similarly, in some embodiments, the incidents tab displays the number of incidents transmitted to an ESP through the emergency response application from the ERDP since the list of incidents was last displayed within the GUI of the emergency response application.

In some embodiments, as illustrated in FIG. 5B, a list of digital emergency service requests 511 includes one or more digital emergency service requests 513 (e.g., the five digital emergency service requests represented by Alert Codes #1-#5) transmitted to an ESP through the emergency response application 560. In some embodiments, as illustrated in FIG. 5B, when the emergency response application 560 is displaying a list of digital emergency service requests 511, the emergency response application 560 also displays one or more emergency locations associated with one or more of the digital emergency service requests 513 (e.g., emergency locations included in or associated with an emergency alert for which a digital emergency service request was generated) as one or more alert locations 525 (e.g., alert locations 525A-525B) within an interactive map 520. In some embodiments, as illustrated in FIG. 5B, a digital emergency service request 513 is associated with an emergency type (e.g., fire, medical, police, etc.), and the emergency response application 560 displays an icon representing the emergency type (also referred to as an “emergency type icon”) associated with the digital emergency service request 513 alongside the digital emergency service request 513 within the list of digital emergency service requests 511. For example, in the example illustrated in FIG. 5B, digital emergency service request 513A is associated with a police emergency type, and the emergency response application 560 displays a police emergency type icon alongside digital emergency service request 513A within the list of digital emergency service requests 511. Similarly, digital emergency service requests 513B and 513C are associated with fire and medical emergency types, respectively, and the emergency response application 560 accordingly displays a fire emergency type icon and a medical emergency type icon alongside digital emergency service request 513B and digital emergency service request 513C, respectively, within the list of digital emergency service requests 511. In some embodiments, an icon displayed within the interactive map 520 for an alert location 525 is displayed in a different shape, size, or color than an icon displayed within the interactive map 520 for an incident location 524. In some embodiments, an icon displayed within the interactive map 520 for an alert location 525 is displayed in the same shape, size, and color as an icon displayed within the interactive map 520 for an incident location 524. In some embodiments, as illustrated in FIG. 5B, a digital emergency service request 513 is displayed within the list of digital emergency service request 511 with emergency data associated with the emergency alert for which the digital emergency service request 513 was generated, such as an alarm code, a location or address, and the date and time at which the emergency alert was generated. In some embodiments, a digital emergency service request 513 is displayed within the list of digital emergency service requests 511 with an indication of a status associated with the digital emergency service request (e.g., whether or not the digital emergency service request 513 has been claimed, as described below).

In some embodiments, as illustrated in FIG. 5C, when a user of the emergency response application 560 selects a digital emergency service request 513 from within the list of digital emergency service requests 511, the emergency response application 560 displays a single alert view. In some embodiments, a single alert view displays additional information or emergency data associated with the selected digital emergency service request 513. In some embodiments, as illustrated in FIG. 5C, the additional information or emergency data associated with the selected digital emergency service request 513 is displayed with a data card 526 separate from the list of digital emergency service requests 511. In some embodiments, as illustrated in FIG. the data card 526 is overlaid atop the interactive map 520. In some embodiments, when the emergency response application 560 displays a single alert view, only the alert location 525 associated with the selected digital emergency service request 513 is displayed within the interactive map 520 (e.g., no other locations are displayed within the interactive map 520). For example, in the example illustrated in FIG. 5C, the digital emergency service request represented by Alert Code #4 has been selected from within the list of digital emergency service request 511. As a result, in this example, the graphical user interface of the emergency response application 560 now displays only the alert location 525D associated with the selected digital emergency service request within the interactive map 520 and a data card 526 overlaid atop the interactive map 520 displaying additional information regarding the selected digital emergency service request. In some embodiments, as illustrated in FIG. 5C, a single alert view provides a user of the emergency response application 560 with access to a two-way communication session 527 (e.g., a text-based communication session) between the ESP accessing the emergency response application 560 and a monitoring center system associated with the selected digital emergency service request 513 (e.g., a monitoring center system that received the emergency alert for which the digital emergency service request was generated, as described above). In some embodiments, information regarding a digital emergency service request, such as statuses, may always be accessible through the two-way communication session 527, but a user of the emergency response application 560 must claim the digital emergency service request (e.g., by selecting a claim button 528) before the user is able to exchange messages with a monitoring center system associated with the digital emergency service request. In some embodiments, a single alert view provides a user of the emergency response application 560 to access a two-way communication session between the ESP accessing the emergency response application 560 and a contact associated with the selected digital emergency service request (e.g., a person associated with the alert source that generated the emergency alert for which the digital emergency service request was generated). In some embodiments, a user of the emergency response application 560 can access a single alert view for a digital emergency service request 513 by selecting an alert location 525 associated with the digital emergency service request 513 from within the interactive map 520.

Responder Dispatch Coordination System

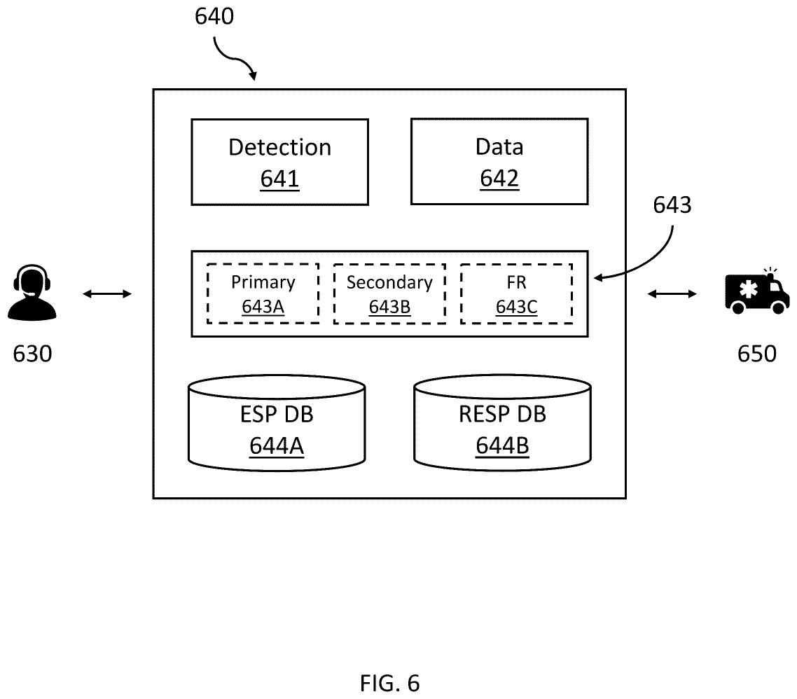

As mentioned above, in various embodiments, disclosed herein is a responder dispatch coordination system that facilitates communications between emergency service providers (ESPs; e.g., primary and secondary ESPs, as described below) and first responders to aid emergency response networks and systems in responding to emergencies. FIG. 6 depicts an exemplary embodiment of a responder dispatch coordination system (RDC). In some embodiments, as depicted in FIG. 6, an RDC 640 is a computing system (e.g., hardware, software, or a combination thereof) that includes one or more modules, such as a dispatch request detection module 641, a responder data management module 642, and an RDC application module 643. In some embodiments, the dispatch request detection module 641 functions to detect dispatch requests generated by ESPs (e.g., primary ESPs) and ingest the dispatch requests into the RDC 640, as described below. In some embodiments, the responder data management module 642 functions to manage the receipt of first responder data from first responders 650 and the transmission of first responder data to ESPs 630 (e.g., primary and secondary ESPs). In some embodiments, the RDC application module 643 functions to provide ESPs 630 (e.g., primary and secondary ESPs) and first responders 650 with graphical user interfaces (GUIs) for interfacing with data and functions provided to the ESPs 630 and first responders 650 by the RDC 640. In some embodiments, as depicted in FIG. 6, the RDC application module 643 provides RDC applications in different forms, such as a primary ESP application 643A, a secondary ESP application 643B, and a first responder application 643C, as described below. In some embodiments, as depicted in FIG. 6, an RDC 640 includes one or more databases 644, such as an ESP database 644A and a responder database 644B. In general, as described in further detail below, the modules of the RDC function together to receive dispatch requests from primary ESPs, forward dispatch requests to first responders, receive data regarding first responders (whether or not those first responders are the recipients of forwarded dispatch requests), and share data regarding first responders with primary and secondary ESPs.

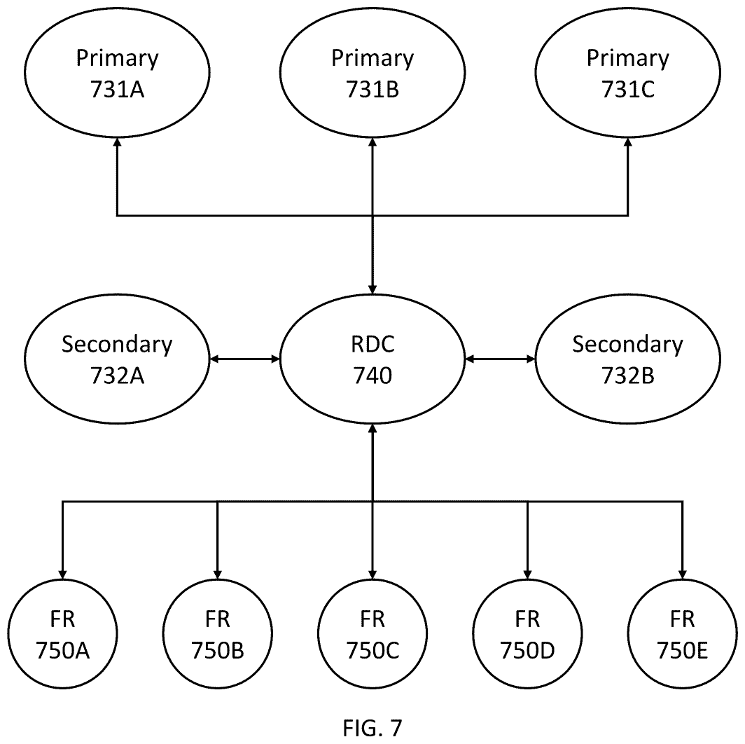

FIG. 7 depicts a diagram of a responder dispatch coordination system (RDC) communicatively coupled to one or more primary emergency service providers (hereinafter, “primary ESPs”), one or more secondary emergency service providers (hereinafter, “secondary ESPs”), and one or more first responders. In some embodiments, an RDC 740 is communicatively coupled only to one or more first responders 750. In some embodiments, an RDC7540 is communicatively coupled only to one or more first responders 750 and one or more secondary ESPs 732. In general, a primary ESP 731 (e.g., a public safety answering point, or “PSAP”) is an ESP that functions primarily to receive primary requests for emergency service (e.g., emergency calls, such as 9-1-1 phone calls in the United States) and transmit dispatch requests to secondary ESPs 732 and first responders 750. In general, a secondary ESP 732 (e.g., a fire department, a police department, or an emergency medical service) is an ESP that functions primarily to manage the dispatching and coordination of first responders 750. In some embodiments, primary ESPs and secondary ESPs are separate and distinct organizations. In some embodiments, a single ESP may perform the functions of both a primary ESP 731 and a secondary ESP 732. In some embodiments, primary ESPs 731 and secondary ESPs 732 have particular relationships, which may be based on various factors, such as geographic location, emergency type, or time and date. For example, primary ESP 731A may be a PSAP in the city of Syracuse, New York, secondary ESP 732A may be a fire department in Syracuse that the PSAP transmits dispatch requests to when the PSAP receives primary requests for emergency service (e.g., emergency calls) regarding fire emergencies, and secondary ESP 732B may be an emergency medical service in Syracuse that the PSAP transmits dispatch requests to when the PSAP receives primary requests for emergency service (e.g., emergency calls) regarding medical emergencies. In general, a first responder 750 (e.g., a firefighter, a police officer, or an emergency medical technician) is a person who responds to emergencies. In some embodiments, a first responder 750 is associated with a particular secondary ESP 732. For example, secondary ESP 732A may be a fire department, and first responders 750A and 750B are firefighters employed by the fire department; while secondary ESP 732B is a police department, and first responders 750C and 750D are police officers employed by the police department. In some embodiments, a first responder 750 is not associated with a particular secondary ESP 732. For example, first responder 750E may be a volunteer emergency medical technician (EMT) that is not employed by any particular emergency medical service.

Dispatch Request Detection

As mentioned above, in general, a responder dispatch coordination system (RDC) functions to receive dispatch requests from primary and secondary ESPs, forward dispatch requests to first responders, receive data regarding first responders, and share data regarding first responders with primary and secondary ESPs. The RDC may receive a dispatch request from an ESP (e.g., a primary ESP) in various ways. In some embodiments, the RDC receives a dispatch request from a primary ESP directly. For example, in some embodiments, the RDC provides an application programming interface (API) that can be integrated into a software application employed by a primary ESP (e.g., a computer aided dispatch system, or “CAD” system), such that when the primary ESP generates a dispatch request within their software application, the dispatch request can be automatically or optionally transmitted directly to the RDC through the API integrated into the software application. Or for example, in some embodiments, the RDC provides one or more email addresses to a primary ESP (hereinafter, “dispatch email addresses”), with which the primary ESP can email dispatch requests directly to the RDC. In some such embodiments, like the API in the previous example, the one or more email addresses can be integrated into a software application employed by a primary ESP (e.g., a CAD system), such that when the primary ESP generates a dispatch request within their software application, the dispatch request can be automatically or optionally emailed directly to the RDC through the one or more email addresses integrated into the software application. In some embodiments, the RDC provides a primary ESP with different dispatch email addresses for different secondary ESPs associated with the primary ESP. The RDC can then determine which secondary ESP to associate a dispatch request with based on the dispatch email address to which the dispatch request was sent. For example, if PSAP A (e.g., a primary ESP) is associated with Fire Department 1 and Police Department 1 (e.g., two secondary ESPs), the RDC can provide PSAP A with a first dispatch email address for Fire Department 1 and a second dispatch email address for Police Department 1. If PSAP A sends a dispatch request to the first dispatch email address, the RDC can simultaneously receive the dispatch request and associate the dispatch request with Fire Department 1. If PSAP A sends a dispatch request to the second dispatch email address, the RDC can simultaneously receive the dispatch request and associate the dispatch request with Police Department 1.

In some embodiments, the RDC receives a dispatch request from a primary ESP indirectly. For example, in some embodiments, the RDC provides or is otherwise communicatively coupled to a radio dispatch monitoring system capable of detecting a dispatch request made by a primary ESP over a radio signal. In many instances, especially in smaller jurisdictions, a primary ESP (e.g., a PSAP) will transmit a dispatch request (e.g., a voice-based dispatch request) to a secondary ESP (e.g., a fire department or a police department) over a radio signal. For example, every secondary ESP that a primary ESP communicates with may be given or otherwise associated with a different radio frequency to listen to at any or all times, such that when the primary ESP transmits a dispatch request to a radio frequency associated with a particular secondary ESP, the particular secondary ESP, and only the particular secondary ESP, will receive the dispatch request. In some embodiments, a radio dispatch monitoring system provided by or otherwise communicatively coupled to the RDC is configured to intercept a dispatch request made by a primary ESP over a radio signal. For example, in some embodiments, the radio dispatch monitoring system is a hardware device associated with a secondary ESP and configured to constantly monitor a radio frequency given to or otherwise associated with the secondary ESP. When a primary ESP transmits a dispatch request over the radio frequency associated with the secondary ESP, the radio dispatch monitoring system detects the dispatch request and transmits an electronic communication regarding the dispatch request to the RDC. In some embodiments, when the radio dispatch monitoring system detects a dispatch request made by a primary ESP over a radio signal, the radio dispatch monitoring system employs a natural language processing module to transcribe the dispatch request, and the transcription of the dispatch request is included in the electronic communication regarding the dispatch request transmitted to the RDC. In some embodiments, when the dispatch monitoring unit detects a dispatch request made by a primary ESP over a radio signal, the radio dispatch monitoring system records the dispatch request into an audio file, and the audio file recording is included in the electronic communication regarding the dispatch request transmitted to the RDC.

In some embodiments, after the RDC detects or otherwise receives a dispatch request made by a primary ESP, the RDC parses the dispatch request for dispatch data. For example, in some embodiments, when the RDC receives a dispatch request in the form of an email (as described above), the RDC parses the contents of the email (e.g., the subject and body of the email) for user or device identifiers (e.g., a name, phone number, or email address associated with the emergency for which the dispatch request was generated) locations, or descriptions associated with the emergency that the dispatch request was made for. Or for example, in some embodiments, when the RDC receives a dispatch request made over a radio signal and transcribes the dispatch request (as described above), the RDC parses the transcription of the dispatch request for names, locations, or descriptions associated with the emergency that the dispatch request was made for. The RDC can then include information extracted from the dispatch request in or along with a dispatch notification generated for the dispatch request and transmitted to one or more first responders, as described below.

Dispatch Request Transmission

In some embodiments, after detecting a dispatch request made by a primary ESP (as described above), the RDC determines one or more first responders to forward or transmit the dispatch request (or a notification regarding the dispatch request, also referred to as a “dispatch notification”) to. The RDC can determine one or more first responders to forward or transmit the dispatch request to in various ways. In some embodiments, the RDC determines one or more first responders to forward or transmit a dispatch request to based at least in part on a location associated with the dispatch request. For example, in some embodiments, if the RDC receives a dispatch request in the form of an email and extracts a location associated with the emergency for which the dispatch request was made (i.e., an emergency location) from the contents of the email, the RDC can use the location to determine one or more first responders to forward or transmit the dispatch request to. Or for example, in some embodiments, when the RDC receives a dispatch request from a primary ESP, the RDC can use a location associated with the primary ESP (e.g., the physical address of the primary ESP) to determine one or more first responders to forward or transmit the dispatch request to. In some embodiments, the RDC receives real-time locations of first responders (e.g., through a first responder application provided to the first responders by the RDC). In such an embodiment, the RDC can use a location associated with a dispatch request and real-time locations of first responders to determine one or more first responders to forward or transmit the dispatch request to. For example, in some embodiments, the RDC forwards or transmits a dispatch request to first responders who have a real-time location within a predetermined radius of a location associated with dispatch request. In some embodiments, the RDC associates different geographic areas of responsibility (hereinafter, “coverage areas”) with different first responders. In such an embodiment, the RDC can use a location associated with a dispatch request and coverage areas associated with first responders to determine one or more first responders to forward or transmit the dispatch request to. For example, in some embodiments, the RDC forwards or transmits a dispatch request to first responders who have a coverage area that a location associated with the dispatch request falls within.

In some embodiments, the RDC determines one or more first responders to forward or transmit a dispatch request to based on first responders' associations with secondary ESPs. As described above, in some embodiments, a primary ESP is associated with one or more secondary ESPs, and the RDC provides different dispatch email addresses to the primary ESP for each secondary ESP that the primary ESP is associated with. As described above, in some embodiments, first responders are associated with secondary ESPs. In such an embodiment, if the RDC can associate a dispatch request with a secondary ESP, the RDC can forward or transmit the dispatch request to one or more first responders associated with the secondary ESP. For example, if a primary ESP sends a dispatch request in the form of an email to a dispatch email address associated with a secondary ESP (as described above), the RDC can forward or transmit the dispatch request to one or more first responders associated with the secondary ESP. Or for example, if a primary ESP makes a dispatch request over a radio frequency (as described above), and a radio dispatch monitoring system associated with a secondary ESP detects the dispatch request and transmits an electronic communication regarding the dispatch request to the RDC (as described above), the RDC can forward or transmit the dispatch request to one or more first responders associated with the secondary ESP. However, the RDC may determine or more first responders to forward or transmit the dispatch request to in any other way.

Once the RDC has detected a dispatch request made by a primary ESP (e.g., by receiving the dispatch request directly or indirectly, as described above) and determined one or more first responders to forward or transmit the dispatch request to, the RDC can forward or transmit the dispatch request to the one or more first responders. As mentioned above, in one aspect, the RDC functions to receive dispatch requests from primary ESPs and transmit dispatch requests to first responders. As described above, the RDC can receive dispatch requests from primary ESPs in various ways. Similarly, in some embodiments, the RDC can transmit dispatch requests to first responders in various ways. For example, in some embodiments, the RDC can transmit a dispatch request to a first responder in the form of a text message. Or for example, the RDC can transmit a dispatch request to a first responder in the form of an email. Or for example, in some embodiments, the RDC can transmit a dispatch request to a first responder through a first responder application (e.g., in the form of a push notification from the first responder application), as described below. In some embodiments, the RDC can transmit a single dispatch request to a first responder in multiple ways. For example, in some embodiments, the RDC can transmit a single dispatch request to a first responder both in the form of a text message and in the form of an email. Or for example, in some embodiments, the RDC can transmit a single dispatch request to a first responder in the form of a text message, in the form of an email, and in the form of a push notification through a first responder application. Transmitting a dispatch request to a first responder in multiple ways provides redundancy that can help ensure that the first responder successfully receives the dispatch request. In some embodiments, a first responder can choose (e.g., through a first responder application) which ways the first responder would like to receive a dispatch request from the RDC. In some embodiments, a dispatch request forwarded or transmitted to a first responder, in any form, includes a link to a website or a first responder application wherein information regarding the dispatch request is displayed, as described below.

First Responder Application

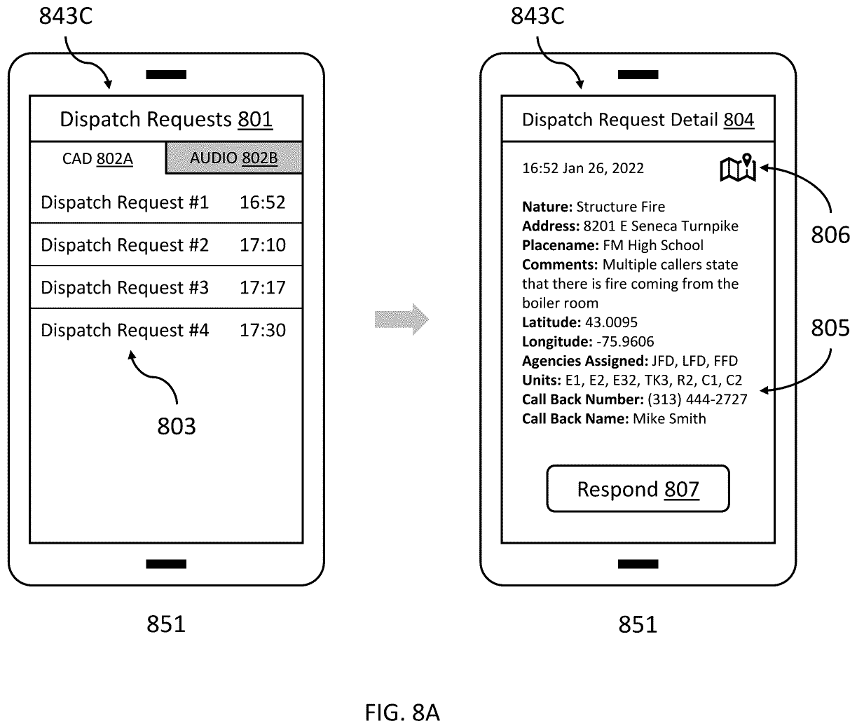

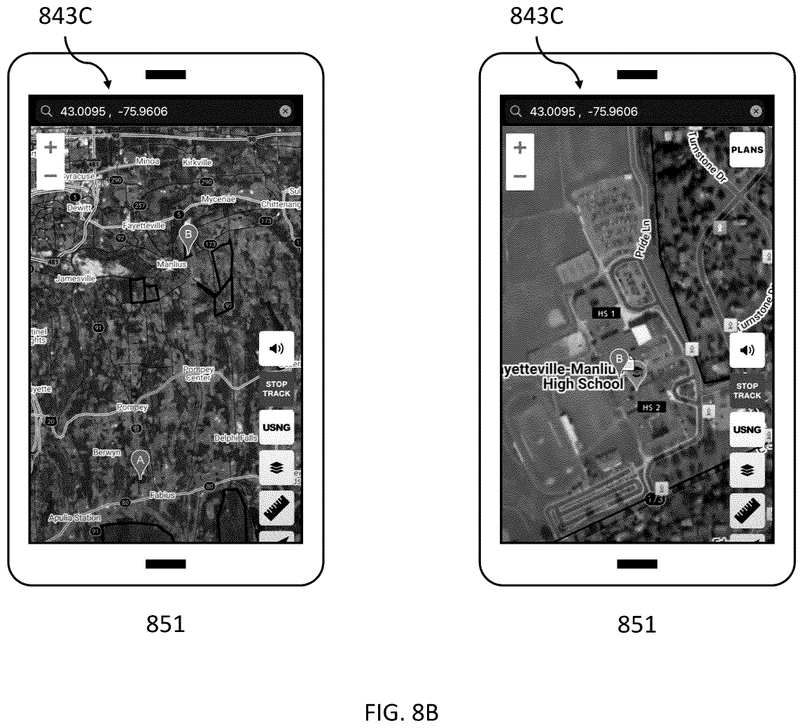

As mentioned above, in some embodiments, the RDC can forward or transmit a dispatch request to a first responder through a first responder application. FIGS. 8A and 8B illustrate an exemplary embodiment of a first responder application provided by the RDC. In some embodiments, as depicted in FIGS. 8A and 8B, the RDC provides first responders with a first responder application 843C that can be executed on an electronic device (e.g., a mobile phone or a tablet). In some embodiments, the first responder application 843C is provided by the RDC in the form of a website or a web application that can be accessed through a standard web browser. In some embodiments, the first responder application 843C is provided by the RDC in the form of an application that can or must be downloaded onto an electronic device. In some embodiments, when the first responder application 843C is first accessed by a first responder, the first responder must sign into the first responder application 843C (e.g., by entering a username or email address and password) or sign up for the first responder application 843C (e.g., by completing a registration process) if the first responder has not yet done so. In some embodiments, when signing up for the first responder application 843C, a first responder must submit i) identification information, such as the first responder's name, age, or qualifications; ii) contact information, such as the first responder's email address or phone number; or iii) one or more secondary ESPs that the first responder is associated with (e.g., a secondary ESP at which the first responder is employed, as described above).

In general, the first responder application 843C functions to receive dispatch requests (or dispatch notifications) and information regarding dispatch requests from the RDC, display dispatch requests and information regarding dispatch requests within a graphical user interface (GUI) of the first responder application 843C, receive information regarding first responders (hereinafter, “responder data”), and transmit responder data to the RDC. In some embodiments, as illustrated in FIG. 8A, the GUI of the first responder application 843C includes a dispatch requests screen 801 that displays a list of dispatch requests 803. In some embodiments, as illustrated in FIG. 8A, the dispatch requests screen 801 includes one or more dispatch request category sections or tabs 802. For example, in the example illustrated by FIG. 8A, the dispatch requests screen 801 includes a first dispatch request category tab 802A for dispatch requests received by the RDC that were generated by or sent from CAD systems (as described above) and a second dispatch request category tab 802B for dispatch requests received by the RDC that were made over a radio frequency (as described above). In the example illustrated by FIG. 8A, the RDC has forwarded or transmitted four dispatch requests (i.e., dispatch requests #1-4) that were generated by or sent from CAD systems to a first responder accessing the first responder application 843C on their first responder device 851. These four dispatch requests are now displayed within the GUI of the first responder application 843C under the first dispatch request category tab 802A for dispatch requests generated by or sent from CAD systems.

In some embodiments, as illustrated by FIG. 8A, a first responder can select a dispatch request from the list of dispatch requests 803 to be shown a dispatch request detail screen 804 that displays information regarding the dispatch request (hereinafter, “dispatch data”). For example, in the example illustrated by FIG. 8A, the first responder accessing the first responder application 843C has selected dispatch request #1 from the dispatch requests screen 801 and is now shown a dispatch request detail screen 804 that displays dispatch data 805 associated with dispatch request #1. In this example, the dispatch data 805 associated with dispatch request #1 includes the day and time that dispatch request #1 was detected or received by the RDC, the nature of the emergency for which dispatch request #1 was made, a location associated with the dispatch request #1, a placename for the location associated with dispatch request #1, comments associated with dispatch request #1, a longitude and latitude coordinate pair for the location associated with dispatch request #1, a list of secondary ESPs that dispatch request #1 was transmitted to, a list of first responders identified as responding to dispatch request #1 (as described below), and a call back name and phone number associated with dispatch request #1 (e.g., the name and phone number of an emergency caller for which dispatch request #1 was made). In the example illustrated by FIG. 8A, from dispatch request #1, the RDC was able to extract dispatch data 805 indicating that dispatch request #1 was made for a structure fire at FM High School, 8201 E Seneca Turnpike. Dispatch data 805 further indicates that the structure fire was reported by a Mike Smith whose phone number is (313) 444-2727, and that three secondary ESPs (e.g., JFD, LFD, and FFD) have been assigned to or otherwise associated with dispatch request #1. In some embodiments, a first responder can identify themselves as responding to a dispatch request by selecting a respond button 807 within the GUI of the first responder application 843C. For example, in the example illustrated by FIG. 8A, the dispatch request detail screen 804 displayed for a selected dispatch request includes a respond button 807 that a first responder can select to identify themselves as responding to the selected dispatch request. However, a respond button may be included on any screen within the GUI of the first responder application 843C. In some embodiments, when a first responder identifies themselves as responding to a dispatch request (e.g., by selecting a respond button within the GUI of a first responder application, as described above), a notification is transmitted to a primary or secondary ESP (e.g., through a primary ESP application or a secondary ESP application, as described below). In some such embodiments, the primary or secondary ESP can respond to the notification to approve or deny the first responder's response to the dispatch request, as described below. In some embodiments, as illustrated by FIG. 8A, the dispatch request detail screen 804 displayed for a selected dispatch request includes a map button 806 that a first responder can select to be shown a location associated with selected dispatch request within a map, as described below.

As mentioned above, in some embodiments, the first responder application 843C can display a location associated with a dispatch request within a map. FIG. 8B illustrates an exemplary embodiment of a map displayed within the GUI of the first responder application 843C. In some embodiments, as illustrated by FIG. 8B, the first responder application 843C displays a location associated with a dispatch request (in this example, location B) and a location associated with the first responder accessing the first responder application 843C (in this example, location A) within the map displayed within the GUI of the first responder application 843C. In some embodiments, as illustrated by FIG. 8B, the first responder application displays directions (e.g., driving directions) from the location associated with the first responder and the location associated with the dispatch request. In some embodiments, as illustrated by FIG. 8B, the first responder application 843C displays locations of other emergency response resources, such as the locations of ESPs or fire hydrants within the map displayed within the GUI of the first responder application 843C.

Secondary ESP Application

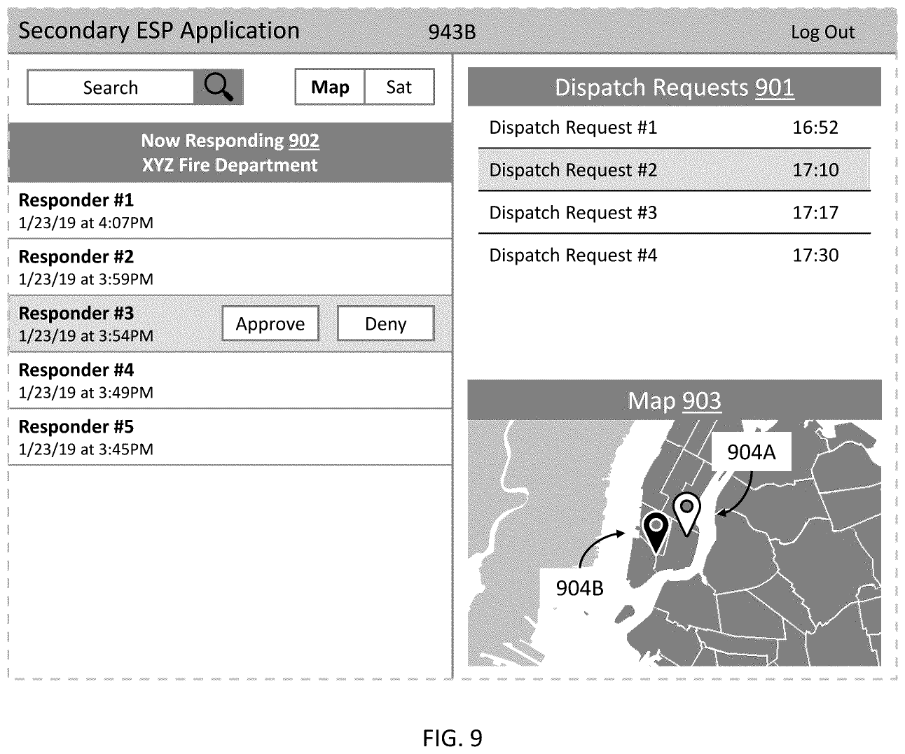

As mentioned above, in some embodiments, the RDC provides secondary ESPs with a secondary ESP application through which secondary ESPs can receive information regarding dispatch requests and first responders. FIG. 9 illustrates an exemplary embodiment of a GUI of a secondary ESP application. In some embodiments, as illustrated by FIG. 9, the GUI of the secondary ESP application 943B includes a list of dispatch requests 901 associated with the secondary ESP accessing the secondary ESP application 943B (in this example, XYZ Fire Department). A dispatch request detected or received by the RDC can be associated with a secondary ESP in various ways. For example, in some embodiments, as described above, when a primary ESP transmits a dispatch request to the RDC in the form of an email, the primary ESP transmits the dispatch request to a dispatch email address associated with a particular secondary ESP. The RDC can then associate the dispatch request with the particular secondary ESP based on the dispatch email address. Or for example, in some embodiments, as described above, when a radio dispatch monitoring system installed at or otherwise associated with a particular secondary ESP detects a dispatch request made by a primary ESP over a radio frequency and transmits an electronic communication regarding the dispatch request to the RDC, the RDC can associate the dispatch request with the particular secondary ESP based on the particular secondary ESP's association with the radio dispatch monitoring system. In some embodiments, a secondary ESP is associated with a dispatch request based on a location associated with the dispatch request. For example, in some embodiments, a secondary ESP is associated with one or more geofences (as described above). In such an embodiment, when the RDC detects or receives a dispatch request and determines a location associated with the dispatch request, the RDC can determine if the location associated with the dispatch request falls within a geofence associated with the secondary ESP. If so, the RDC can associate the dispatch request with the secondary ESP. In some embodiments, the RDC can associate a dispatch request with a secondary ESP based on the secondary ESP's association with a first responder. For example, if a first responder identifies as responding to a dispatch request (such as through the first responder application, as described above), and the first responder is associated with a secondary ESP (as described above), the RDC can associate the dispatch request with the secondary ESP based on the shared association with the first responder. However, the RDC can associate a dispatch request with a secondary ESP in any other way.

In some embodiments, as illustrated by FIG. 9, the GUI of the secondary ESP application 943B includes a list of dispatched first responders 902 associated with the secondary ESP. A first responder can be associated with a secondary ESP in various ways. For example, in some embodiments, as described above, a first responder can submit to the RDC one or more secondary ESPs that the first responder is associated with through the first responder application. Or for example, in some embodiments, if a first responder identifies themselves as responding to a dispatch request that is associated with a particular secondary ESP, the RDC can associate the first responder (e.g., temporarily associate) with the secondary ESP based on the shared association with the dispatch request. In some embodiments, the RDC can associate a first responder with a secondary ESP based on location. For example, in some embodiments, a secondary ESP is associated with one or more geofences (as described above). If the RDC receives a location associated with a first responder (e.g., through the first responder application, which may be able to receive or determine the location of the first responder from the first responder device through which the first responder is accessing the first responder application), the RDC can determine if the location associated with the first responder falls within a geofence associated with the secondary ESP. If so, the RDC can associate the first responder with the secondary ESP. However, the RDC can associate a first responder with a secondary ESP in any other way. In some embodiments, the list of dispatched first responders 902 displays first responders who have identified themselves as responding to a dispatch request associated with the secondary ESP accessing the secondary ESP application 943B. In some embodiments, the list of dispatched first responders 902 displays first responders who both a) are associated with the secondary ESP accessing the secondary ESP application 943B and b) have identified themselves as responding to a dispatch request.

In some embodiments, as illustrated by FIG. 9, the GUI of the secondary ESP application 943B includes a map 903. In some embodiments, the map 903 displays locations associated with dispatch requests associated with the secondary ESP accessing the secondary ESP application 943B. For example, in the example illustrated by FIG. 9, the map 903 displays a location 904A associated with dispatch request #2, which has been selected within the list of dispatch requests 901. In some embodiments, the map 903 displays a location associated with each of the dispatch requests in the list of dispatch requests 901 associated with the secondary ESP accessing the secondary ESP application 943B simultaneously. In some embodiments, the map 903 displays only a location associated with the dispatch request selected within the list of dispatch requests 901. In some embodiments, the map 903 displays locations associated with first responders. For example, in the example illustrated by FIG. 9, the map 903 displays a location associated with responder #3, who has been selected within the list of dispatched first responders 902. In some embodiments, the map 903 displays a location associated with each of the first responders in the list of dispatched first responders 902 simultaneously. In some embodiments, the map 903 displays only a location associated with the first responder selected within the list of dispatched first responders 902. In some embodiments, as illustrated by FIG. 9, the map 903 displays one or more locations associated with dispatch requests and one or more locations associated with first responders simultaneously. In some embodiments, as illustrated by FIG. 9, locations associated with dispatch requests and locations associated with first responders are displayed within the map 903 in different shapes or colors.

In some embodiments, a user of the secondary ESP application 943B (e.g., a secondary ESP administrator, such as a fire department chief) can use the secondary ESP application 943B to approve or deny a first responder's response to a dispatch request. For example, in some embodiments, as illustrated by FIG. 9, a user of the secondary ESP application 943B can select a first responder from the list of dispatched first responders 902 and select an approve button to approve the first responder's response to a dispatch request or select a deny button to deny the first responder's response to a dispatch request. Or for example, in some embodiments, when a first responder identifies themselves as responding to a dispatch request (as described above), a notification is sent to a secondary ESP associated with the first responder or the dispatch request (as described above) through the secondary ESP application 943B. In some embodiments, a user of the secondary ESP application 943B can respond to the electronic notification by selecting an approve button or a deny button to approve or deny the first responder's response to the dispatch request. In some embodiments, when a user of the secondary ESP application approves or denies a first responder's response to a dispatch request, a notification is transmitted to the first responder (e.g., as a push notification from a first responder application, or in the form or an email or text message) notifying the first responder of the secondary ESP's approval or denial.

Primary ESP Application

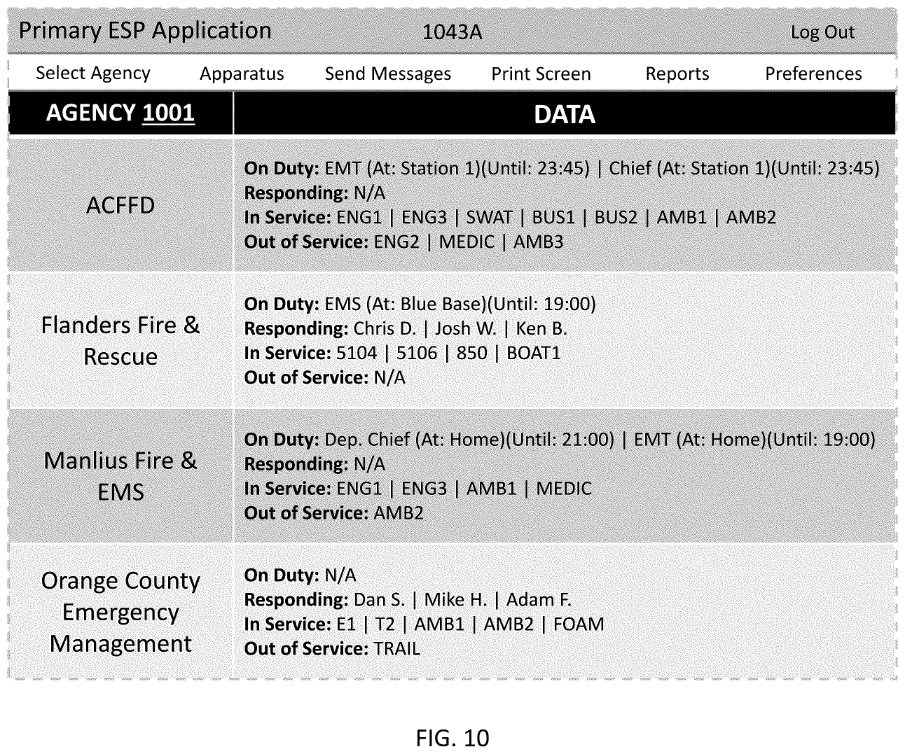

As mentioned above, in some embodiments, the RDC provides primary ESPs with a primary ESP application through which primary ESPs can receive information regarding first responders and secondary ESPs. FIG. 10 illustrates an exemplary embodiment of a GUI of a primary ESP application. In some embodiments, as illustrated by FIG. 10, the GUI of the primary ESP application 1043A includes a list of secondary ESPs 1001 that the primary ESP accessing the primary ESP application is associated with (as described above). For example, in the example illustrated by FIG. 10, the primary ESP application 1043A displays four secondary ESPs within the list of secondary ESPs 1001 associated with the primary ESP accessing the primary ESP application 1043A: ACFFD, Flanders Fire & Rescue, Manlius Fire & EMS, and Orange County Emergency Management. In some embodiments, as illustrated by FIG. 10, the GUI of the primary ESP application 1043A includes information regarding one or more secondary ESPs (e.g., one or more secondary ESPs within the list of secondary ESPs 1001) or information regarding one or more first responders (e.g., one or more first responders associated with the one or more secondary ESPs within the list of secondary ESPs 1001 or one or more first responders associated with one or more dispatch requests made by the primary ESP accessing the primary ESP application 1043A). For example, in the example illustrated by FIG. 10, for each secondary ESP within the list of secondary ESPs 1001, the primary ESP application 1043A displays four categories of information: first responders on duty, dispatched first responders, response units (e.g., firetrucks, ambulances, police cars, etc.) in service, and response units out of service. In some embodiments, the information regarding secondary ESPs or first responders displayed within the primary ESP application 1043A is received by the RDC from the secondary ESPs or first responders through the secondary ESP application or the first responder application, respectively. In some embodiments, the primary ESP application 1043A provides an interface for primary ESPs to send messages to secondary ESPs or first responders. For example, in some embodiments, a user of the primary ESP application can select a send messages button, which prompts the primary ESP application 1043A to display a messaging interface. Through the messaging interface, the user of the primary ESP application 1043A can submit a message, select a secondary ESP or a first responder, and transmit the message to the secondary ESP or the first responder. In some embodiments, the message can be transmitted and displayed to the secondary ESP through the GUI of the secondary ESP application (as described above). In some embodiments, the message can be transmitted and displayed to the first responder through the GUI of the first responder application (as described above). In some embodiments, the message can be transmitted to the first responder in the form of a text message or an email.

ERDP & RDC Integration

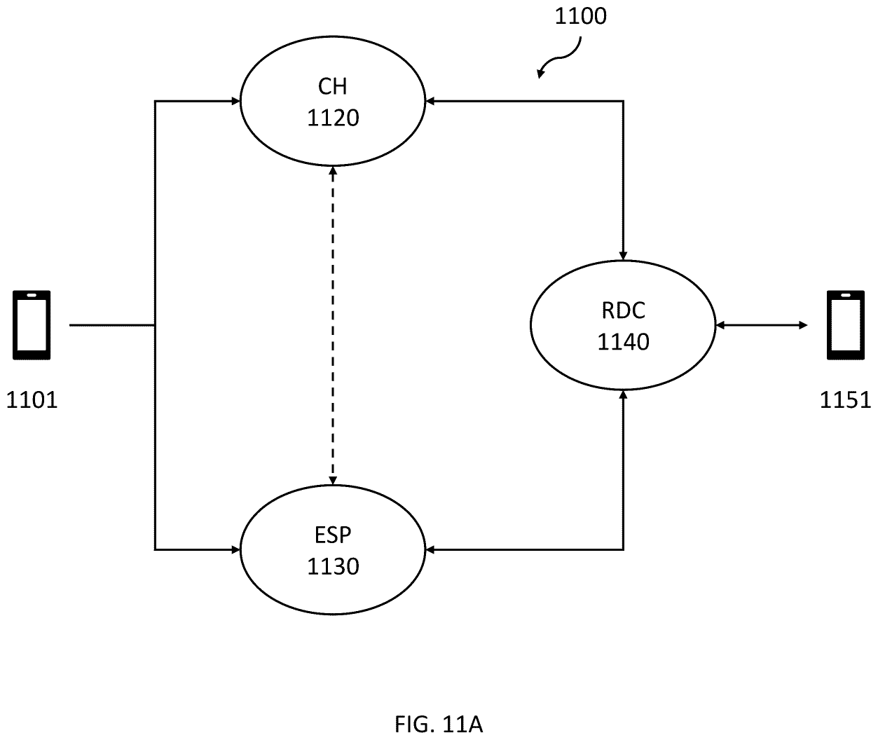

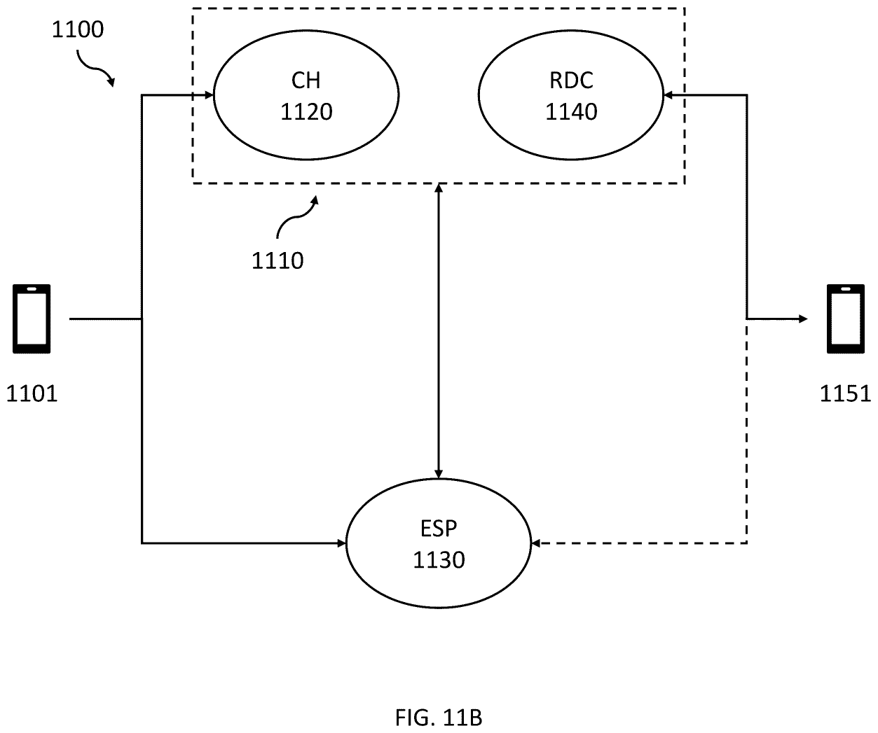

In various embodiments, as described above, disclosed herein is an emergency response data platform (ERDP) capable of receiving emergency data (e.g., device-based hybrid locations and additional emergency information, such as health data, medical data, and multimedia) from smart devices and systems (e.g., mobile phones and IoT devices) and transmitting the emergency data to emergency service providers (ESPs) to assist the ESPs in responding to emergencies. In various embodiments, also described above, disclosed herein is a responder dispatch coordination system (RDC) that facilitates communications between ESPs and first responders to aid emergency response networks and systems in responding to emergencies. In various embodiments, as described below, the RDC can be integrated with or into the ERDP to provide emergency response assistance to ESPs and first responders. FIGS. 11A and 11B depict exemplary embodiments of a system 1100 for providing emergency response assistance to ESPs and first responders. In some embodiments, as depicted in FIG. 11A, a system 1100 for providing emergency response assistance to ESPs and first responders includes an emergency data source (e.g., a clearinghouse 1120, as described above), an ESP 1130 (e.g., a primary or secondary ESP, as described above), and an RDC 1140 (as described above). In some embodiments, as depicted in FIG. 11A, the clearinghouse 1120 is communicatively coupled to the ESP 1130 or the RDC 1140. In some embodiments, as depicted in FIG. 11A, the RDC 1140 is communicatively coupled to the clearinghouse 1120 or the ESP 1130. In some embodiments, as depicted in FIG. 11A, the system 1100 additionally includes one or more electronic devices 1101 (e.g., a mobile phone associated with an emergency caller). In some embodiments, as depicted in FIG. 11A, the one or more electronic devices 1101 are communicatively coupled to the clearinghouse 1120 or the ESP 1130. In some embodiments, as depicted in FIG. 11A, the system 1100 additionally includes one or more first responder devices 1151 (as described above). In some embodiments, as depicted in FIG. 11A, the one or more first responder devices 1151 are communicatively coupled to the RDC 1140 (e.g., through a first responder application, as described above). In some embodiments, as depicted in FIG. 11B, the clearinghouse 1120 and the RDC 1140 are components of the same emergency response data platform 1110 (as described above).

Emergency Data Transmission to First Responders

As mentioned above, in various embodiments, an RDC can be integrated with or into an ERDP to provide emergency response assistance to first responders. In some embodiments, the ERDP (e.g., an emergency data source) can provide emergency data to the RDC. The RDC can then provide the emergency data to one or more first responders. For example, in some embodiments, as depicted in FIGS. 11A and 11B, when an electronic device 1101 (e.g., a mobile phone) delivers a request for emergency service (e.g., by dialing 9-1-1 in the United States) to an ESP 1130 (e.g., a primary ESP, as described above), the electronic device 1101 also transmits an emergency alert to the ERDP (e.g., through the clearinghouse 1120, as described above). In some embodiments, as described above, the emergency alert includes a user or device identifier (e.g., a phone number) and an emergency location generated by the electronic device 1101. After receiving the request for emergency service, the ESP 1130 can then generate and transmit a dispatch request regarding the request for emergency service to the RDC 1140. In some embodiments, as described above, the RDC 1140 can parse or extract dispatch data from the dispatch request, such as a user or device identifier (e.g., a phone number) associated with the dispatch request. In some embodiments, if the RDC 1140 is communicatively coupled to the clearinghouse 1120, the RDC can transmit an emergency data request including the user or device identifier (e.g., a phone number associated with the dispatch request) to the clearinghouse 1120. The clearinghouse 1120 can then gather any available emergency data associated with the user or device identifier, such as the emergency location generated by the electronic device 1101, and return the emergency data to the RDC 1140. The RDC 1140 can then transmit the emergency data to one or more first responder devices 1151, such as through a first responder application (as described above). In some embodiments, the RDC 1140 transmits an emergency data request including a user or device identifier associated with a dispatch request to an emergency data source (e.g., the clearinghouse 1120) only after the dispatch request has been selected from a list of dispatch requests displayed within a dispatch request screen of a first responder application (as described above). In some embodiments, the RDC 1140 transmits an emergency data request including a user or device identifier associated with a dispatch request as soon as the RDC 1140 receives the dispatch request from an ESP 1130 (as described above). In some embodiments, the RDC 1140 transmits emergency data received from an emergency data source (e.g., the clearinghouse 1120) and associated with a dispatch request to a first responder device 1151 only after the dispatch request has been selected from a list of dispatch requests displayed within a dispatch request screen of a first responder application executed on or otherwise accessed by the first responder device 1151. In some embodiments, after the RDC 1140 receives a dispatch request from an ESP 1130, the RDC 1140 can transmit emergency data requests including a user or device identifier associated with the dispatch request to two or more different emergency data sources, such as for different types of emergency data (e.g., personal data, medical data, multimedia, etc.). Similarly, in some embodiments, the RDC 1140 can transmit emergency data regarding a single dispatch request and received from two or more different emergency data sources to one or more first responder devices 1151.

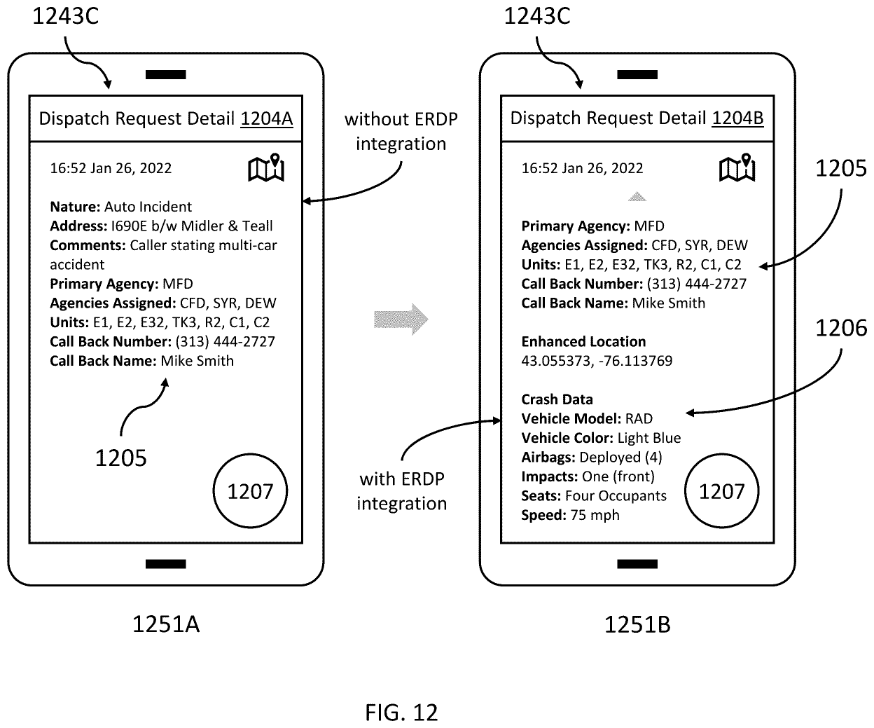

FIG. 12 illustrates an exemplary embodiment of emergency data received by the RDC, transmitted to a first responder device, and displayed within the graphical user interface (GUI) of a first responder application. As described above, in some embodiments, the RDC can query the ERDP (e.g., through the clearinghouse) by transmitting an emergency data request including a user or device identifier to the ERDP. After receiving the emergency data request from the RDC, the ERDP can use the user or device identifier to gather any available emergency data associated with the user or device identifier and return the emergency data to the RDC. The RDC can then transmit the emergency data to one or more first responders (e.g., to one or more first responder devices) to be displayed within the GUI of a first responder application, as illustrated by FIG. 12. In the example illustrated in FIG. 12, the GUI of the first responder application 1243C executed on or otherwise accessed by first responder device 1251A displays a dispatch request detail screen 1204A, within which the first responder application 1243C displays dispatch data 1205 extracted from a dispatch request by the RDC. In this example, the dispatch data 1205 that the RDC was able to extract from the associated dispatch request includes a nature of the emergency (e.g., “auto incident”), a rough description of a location associated with the dispatch request (e.g., “I690E b/w Midler & Teall”), comments, primary and secondary ESPs associated with the dispatch request, units dispatched for the dispatch request, and a call back name and number associated with the dispatch request (e.g., Mike Smith and Mike Smith's phone number). The dispatch request detail screen 1204A also displays a respond button 1207 that a first responder can select to identify themselves as responding to the dispatch request (as described above). For the same example dispatch request, the GUI of the first responder application 1243C executed on or otherwise accessed by first responder device 1251B displays a dispatch request detail screen 1204B, within which the first responder application 1243C displays the dispatch data 1205 that the RDC was able to extract from the dispatch request as well as emergency data associated with the dispatch request that the RDC has received from the ERDP (as described above). In this example, the ERDP received an emergency alert generated by a vehicle telematics system included in the car that experienced the auto incident for which the dispatch request was made. The emergency alert included emergency data generated by the vehicle telematics system, including a user or device identifier associated with the vehicle telematics system (e.g., a phone number associated with the owner of the car; in this example, Mike Smith's phone number), a location generated by the car, the model and color of the car, whether or not airbags were deployed, where the car was impacted, how many occupants were in the car, and the speed that the car was moving at the time of the incident. When the RDC received the dispatch request (as described above), the RDC extracted a user or device identifier associated with the dispatch request (e.g., a phone number associated with the dispatch request) and transmitted an emergency data request including the user or device identifier associated with the dispatch request to the ERDP. Using the user or device identifier associated with the dispatch request included in the emergency data request, the ERDP was able to retrieve the emergency data generated by the vehicle telematics system, which was associated with the same user or device identifier, and return the emergency data generated by the vehicle telematics system to the RDC. The RDC then transmitted the emergency data generated by the vehicle telematics system to the first responder device 1251B through the first responder application 1243C, where the emergency data 1206 is now displayed within the dispatch request detail screen 1204B. With the additional information provided by the emergency data 1206, the first responder accessing the first responder application 1243C on their first responder device 1251B will be more prepared to respond to the emergency associated with the dispatch request (e.g., the auto incident).

In some embodiments, the RDC can transmit an emergency data request including a location or geofence of interest (also referred to as a “geospatial query”) to the ERDP. After receiving the geospatial query, the ERDP can gather emergency data associated with the location or geofence of interest (e.g., emergency data associated with locations within or within a threshold proximity of the location or geofence of interest) and return the emergency data to the RDC. The RDC can then provide the emergency data to one or more first responders. In some embodiments, the geospatial query transmitted to the ERDP by the RDC includes a geofence of interest. In some embodiments, the geospatial query transmitted to the ERDP by the RDC includes a location of interest, and the ERDP generates a geofence of interest by applying a radius to the location of interest. In some embodiments, emergency data associated with a location or geofence of interest includes emergency alert (e.g., current emergency alerts), historic emergency alerts, emergency response assets, responder data (e.g., responder locations), or sensor data (e.g., sensor locations). However, emergency data associated with a location or geofence of interest may include any other data.

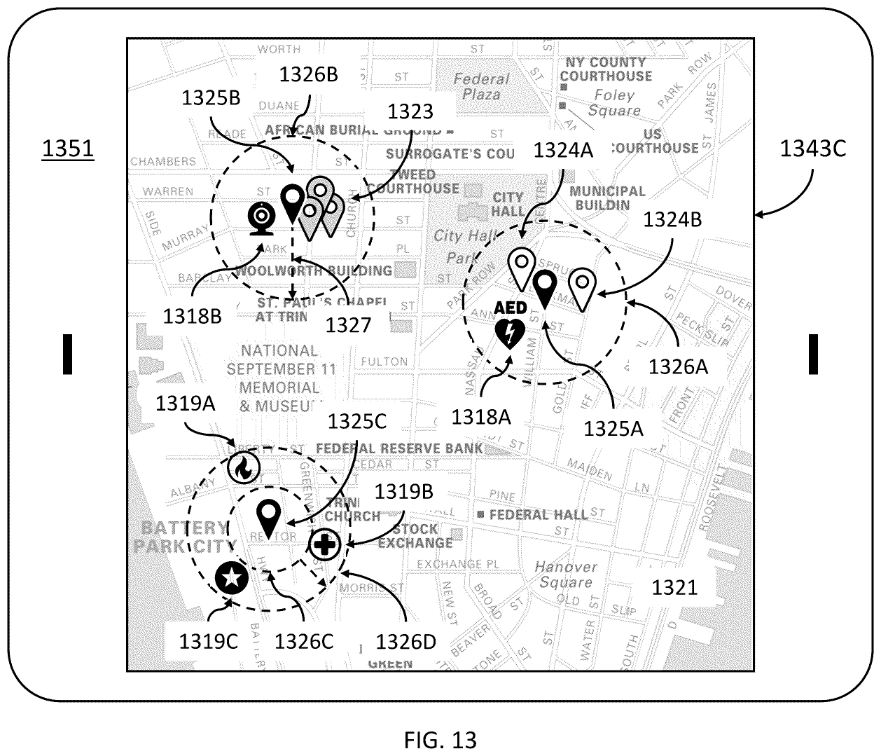

FIG. 13 illustrates three examples of geospatial queries transmitted to the ERDP from the RDC and emergency data returned to the RDC by the ERDP in response to the geospatial queries. In the first example, a first responder has selected a location of interest 1325A within a map 1321 within a graphical user interface (GUI) of a first responder application 1343C executed on or otherwise accessed by the first responder's first responder device 1351 (e.g., a tablet device). In this example, in response to detecting the first responder's selection of the location of interest 1325A within the map 1321, the first responder application 1343C prompts the RDC to transmit a geospatial query comprising the location of interest 1325A to the ERDP. In this example, after receiving the geospatial query comprising the location of interest 1325A, the ERDP applied a radius around the location of interest 1325A to generate a geofence of interest 1326A and retrieved any available emergency data associated the geofence of interest 1326A (e.g., any available emergency data associated with locations within the geofence of interest 1326A). In this example, the emergency data associated with locations within the geofence of interest 1326A identified by the ERDP included two emergency alerts (e.g., current emergency alerts), each including at least a user or device identifier and an emergency location associated with the respective emergency alert, and a location associated with an emergency response asset (e.g., a smart AED) The ERDP returned the emergency data associated with the geofence of interest 1326A to the RDC, which in turn transmitted the emergency data to the first responder's first responder device 1351 through the first responder application 1343C, which now displays the emergency locations 1324A and 1324B associated with the two emergency alerts and the location associated with the emergency response asset 1318A within the map 1321 within the GUI of the first responder application 1343C. In the second example, the first responder has clicked on a point within the map 1321 within the GUI of the first responder application 1343C to select a location of interest 1325B and dragged a straight line down and away from the location of interest 1325B to apply a radius 1327 around the location of interest 1325B and thereby generate a geofence of interest 1326B. In this example, in response to detecting the first responder's selection of the location of interest 1326A and subsequent generation of the geofence of interest 1326B, the first responder application 1343C prompts the RDC to transmit a geospatial query comprising the geofence of interest 1326B to the ERDP. In this example, after receiving the geospatial query including the geofence of interest 1326B, the ERDP retrieved any available emergency data associated with locations within the geofence of interest 1326B. In this example, the emergency data associated with the geofence of interest 1326B included three historic emergency alerts, each including at least a user or device identifier and an emergency location associated with the respective historic emergency alert, and a location associated with a sensor (e.g., a traffic camera). The ERDP returned the emergency data associated with the geofence of interest 1326B to the RDC, which in turn transmitted the emergency data to the first responder's first responder device 1351 through the first responder application 1343C, which now displays the historic locations 1323 associated with the three historic emergency alerts and the location associated with the sensor 1318B within the map 1321 within the GUI of the first responder application 1343C. In the third example, the first responder has selected a dispatch request from within a list dispatch request displayed within a dispatch requests screen of the first responder application 1343C (as described above) and then selected a map button from within a dispatch request detail screen (as described below), prompting the first responder application 1343C to display a location associated with the dispatch request within a map 1321. In this example, in response to displaying the location associated with the dispatch request 1325C within the map 1321, the first responder application 1343C prompts the RDC to apply a radius around the location associated with the dispatch request 1325C to generate a geofence of interest 1326C and transmit a geospatial query including the geofence of interest 1326C to the ERDP. In this example, after receiving the geospatial query including the geofence of interest 1326C, the ERDP attempted to retrieve any available emergency data associated with the geofence of interest 1326C but found none. In this example, in response to finding no emergency data associated with the geofence of interest 1326C, the ERDP automatically increased the radius of the geofence of interest 1326C to generate a new geofence of interest 1326D. The ERDP then retrieved any available emergency data associated with the geofence of interest 1326D. In this example, the emergency data associated with the geofence of interest 1326D included three responder locations 1319A-1319C (e.g., a location associated with a firefighter 1319A, a location associated with an EMT 1319B, and a location associated with a police officer 1319C). The ERDP returned the emergency data associated with the geofence of interest 1326C to the RDC, which in turn transmitted the emergency data to the first responder's first responder device 1351 through the first responder application 1343C, which now displays the three responder locations 1319A-1319C within the map 1321 within the GUI of the first responder application 1343C.

In some embodiments, the RDC can transmit an emergency data request to the ERDP that is unrelated to any dispatch request received by the RDC or emergency alert received by the ERDP. As described above, in some embodiments, the ERDP stores or is otherwise capable of accessing or retrieving emergency data that is not generated or gathered for a particular emergency alert. For example, in some embodiments, the ERDP stores or otherwise capable of accessing personal data or medical data that is gathered from a person before that person experiences an emergency, so that the personal or medical data may be available to ESPs or first responders as soon as it is desired. For example, in some embodiments, the ERDP provides a web application through a person can submit personal data (e.g., home locations, emergency contacts, demographic information, etc.) or medical data (e.g., medical history, allergies, current medications, etc.) to be stored by the ERDP for future retrieval, should the person experience an emergency. Or for example, in some embodiments, a person may register or integrate an electronic device (e.g., a smartwatch) with the ERDP, such that the ERDP may retrieve data from the electronic device (e.g., heartrate data) in the event that the person experiences an emergency. In some embodiments, as described above, emergency data (e.g., personal data or medical data) stored by or otherwise accessible to the ERDP is associated with a user or device identifier (e.g., a phone number or an email address).

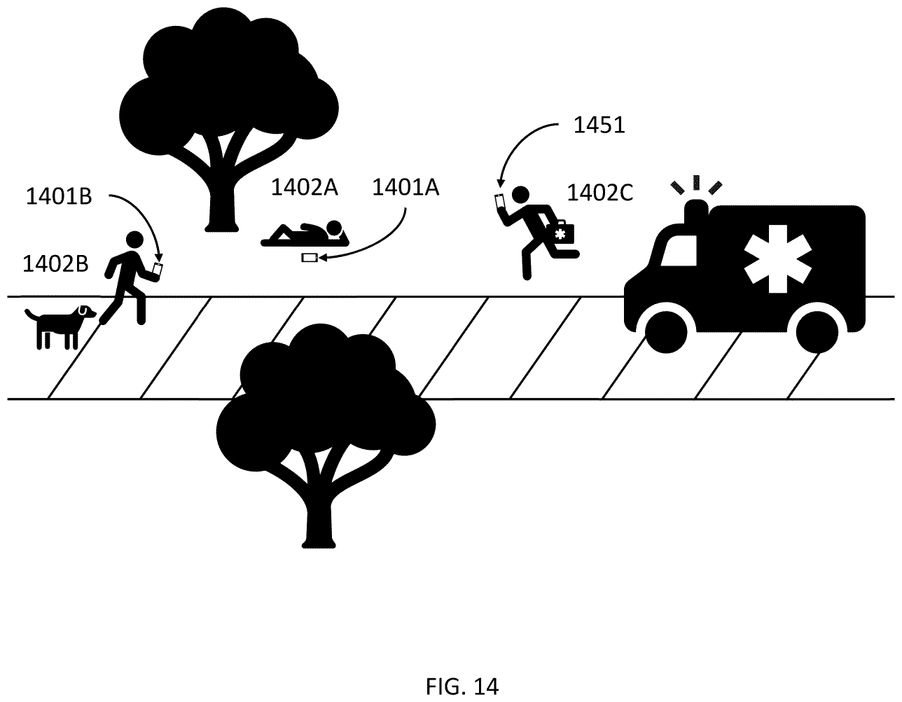

FIG. 14 illustrates an example of the RDC transmitting an emergency data request to the ERDP that is unrelated to unrelated to a dispatch request received by the RDC or an emergency alert received by the ERDP. In the example illustrated by FIG. 14, a jogger 1402A has collapsed in a park. A dog walker 1402B saw the jogger 1402A fall and fail to get up, so the dog walker 1402B called 9-1-1 on the jogger's behalf. A primary ESP (e.g., a PSAP) received the dog walker's 9-1-1 call and generated a dispatch request for the jogger's emergency that was received by the RDC. The RDC then transmitted the dispatch request to a first responder 1402C through a first responder application (as described above) executed on the first responder's first responder device 1451. The first responder 1402C immediately makes their way to the location included in the dispatch request (e.g., the dog walker's location, which is virtually the same as the collapsed jogger's location). However, the dispatch request included the phone number of the dog walker 1402B, because it was the dog walker 1402B that called 9-1-1, not the collapsed jogger 1402A. Similarly, an emergency alert was generated by the dog walker's electronic device 1401B (e.g., the dog walker's mobile phone) and transmitted to the ERDP, but the emergency alert also included the phone number of the dog walker 1402B, not the phone number of the collapsed jogger 1402A. Thus, the ERDP was unable to gather and transmit emergency data associated with the collapsed jogger 1402A to the RDC, and the RDC was unable to request emergency data associated with the collapsed jogger 1402A from the ERDP. In this example, when the first responder 1402C arrives at the location of the emergency, the first responder's first responder device 1451 can wirelessly communicate with the jogger's electronic device 1401A (e.g., using near-field communication or Bluetooth technology) to receive or identify a user or device identifier (e.g., a phone number) associated with the jogger's electronic device 1401A. The first responder application executed on the first responder device 1451 receives the user or device identifier associated with the jogger's electronic device 1401 from the first responder device 1451 and then prompts the RDC to transmit an emergency data request including the user or device identifier associated with the jogger's electronic device 1401A to the ERDP, which in turn gathers any available emergency data associated with the user or device identifier (e.g., medical data that the jogger 1402A previously submitted to the ERDP) and transmits the emergency data to the RDC. The RDC then transmits the emergency data associated with the user or device identifier associated with the jogger's electronic device 1401A to the first responder device 1451 through the first responder application for display within a GUI of the first responder application (as described above).

In some embodiments, the ERDP can transmit emergency data to the RDC without receiving an emergency data request from the RDC. For example, in some embodiments, when the ERDP receives an emergency alert (as described above), the ERDP can transmit the emergency alert to the RDC without receiving an emergency data request from the RDC and without the RDC first receiving a dispatch request associated with the emergency alert. Or for example, in some embodiments, when the ERDP receives an emergency alert (as described above), the ERDP can transmit the emergency alert to the RDC without receiving an emergency data request from the RDC and before the RDC receives a dispatch request associated with the emergency alert. In some embodiments, when the RDC receives an emergency alert from the ERDP before or without receiving a dispatch request associated with the emergency alert, the RDC determines one or more first responders to forward or transmit the emergency alert to. The RDC can determine one or more first responders to forward or transmit an emergency alert to in various ways. In some embodiments, when the emergency alert includes an emergency location, the RDC can determine one or more first responders to forward or transmit the emergency alert to based at least in part on the emergency location. For example, in some embodiments, after receiving an emergency alert including an emergency location, the RDC can use the emergency location and real-time locations for first responders (as described above) to determine or more first responders to forward or transmit the emergency alert to. For example, in some embodiments, the RDC forwards or transmits the emergency alert to first responders who have a real-time location within a predetermined radius of the emergency location. Or for example, in some embodiments, the RDC can use the emergency location and coverage areas associated with first responders (as described above) to determine one or more first responders to forward or transmit the emergency alert to. For example, in some embodiments, the RDC forwards or transmits the emergency alert to first responders who have a coverage area that the emergency location falls within. In some embodiments, the RDC determines one or more first responders to forward or transmit an emergency alert to based on first responders' association with secondary ESPs. For example, in some embodiments, when the ERDP receives an emergency alert including an emergency location, the ERDP cross references the emergency location with a database of geofences associated with primary ESPs (as described above). If the ERDP determines that the emergency location falls within a geofence associated with a particular primary ESP, the ERDP can tag or associate the emergency alert with an identifier associated with the particular primary ESP (also referred to as an “ESP identifier”), as described above. As described above, in some embodiments, a primary ESP is associated with one or more secondary ESPs, and a secondary ESP is associated with one or more first responders. Thus, in such an embodiment, when the RDC receives, from the ERDP, an emergency alert associated with a particular primary ESP (e.g., the emergency alert is tagged with an identifier associated with the particular primary ESP), the RDC can identify one or more secondary ESPs associated with the primary ESP, and then identify one or more first responders associated with the one or more ESPs to forward or transmit the emergency alert to. However, the RDC can determine one or more first responders to forward or transmit an emergency alert to in any other way. Similarly, in some embodiments, when the RDC receives an emergency alert from the ERDP, the RDC can determine one or more secondary ESPs to forward or transmit the emergency alert to (e.g., for display within the GUI of a secondary ESP application, as described above).

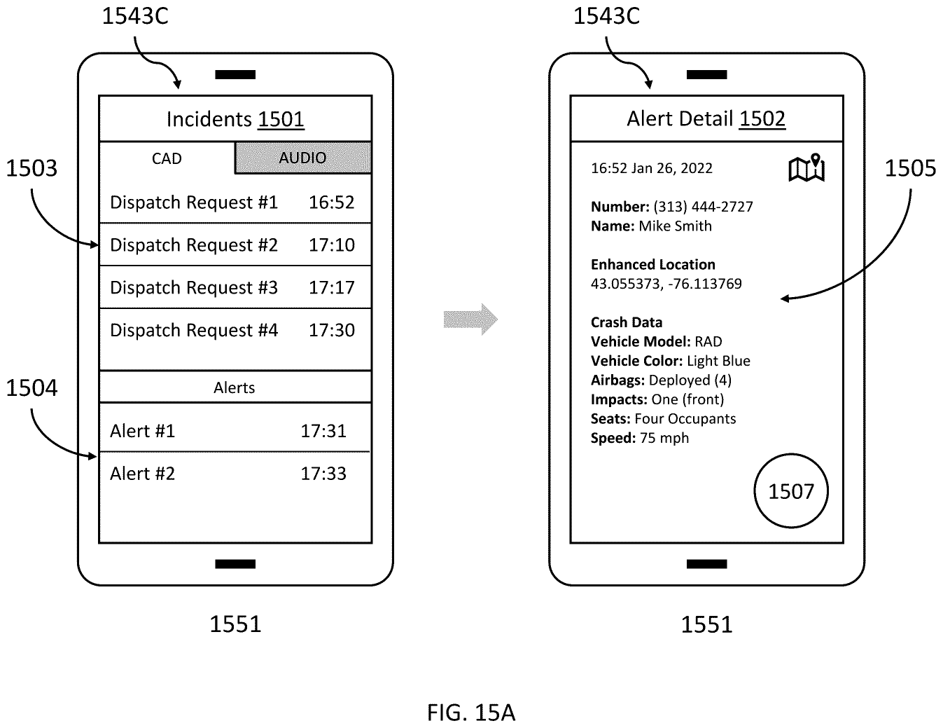

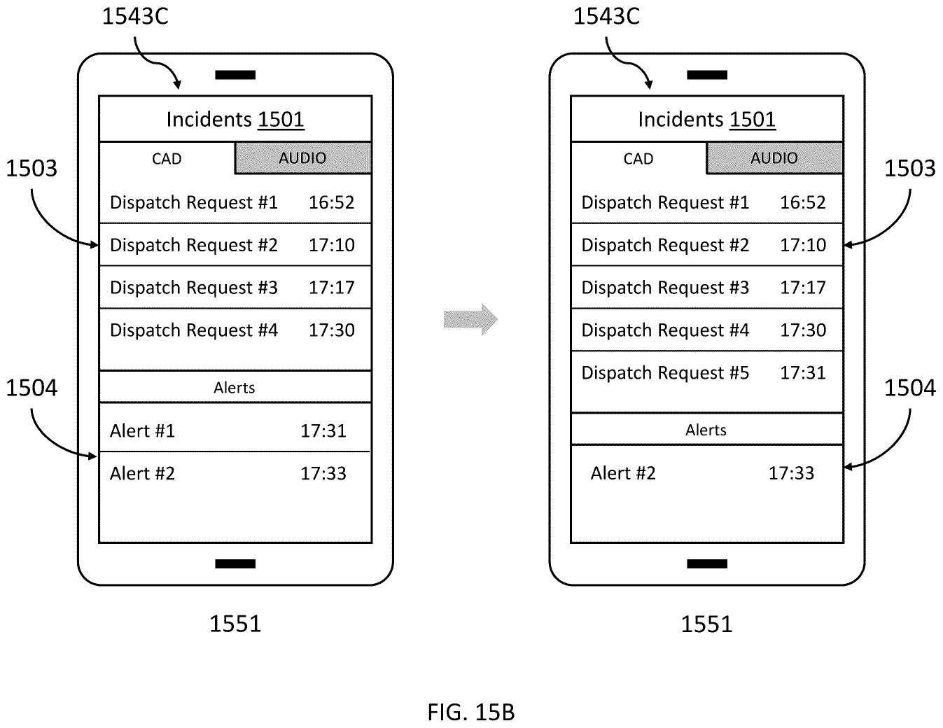

FIGS. 15A and 15B illustrate exemplary embodiments of emergency alerts transmitted by the ERDP to the RDC and displayed within a graphical user interface (GUI) of a first responder application. In some embodiments, as illustrated by FIG. 15A, when the RDC forwards or transmits an emergency alert to a first responder, the emergency alert is transmitted to the first responder's first responder device 1551 through a first responder application 1543C. In some embodiments, an emergency alert transmitted to a first responder device 1551 through a first responder application 1543C is displayed within a list of emergency alerts 1504 within an incidents screen 1501. In some embodiments, as illustrated by FIG. 15A, the incidents screen 1501 displays both a list of emergency alerts 1504 and a list of dispatch requests 1503 (as described above) transmitted to the first responder device 1551. In the example illustrated by FIG. 15A, the RDC has received two emergency alerts (i.e., emergency alerts #1 and #2) from the ERDP and transmitted the two emergency alerts to a first responder accessing the first responder application 1543C on their first responder device 1551. The two emergency alerts are now displayed within the GUI of the first responder application 1543C within the list of emergency alerts 1504. In some embodiments, as illustrated by FIG. 15A, a first responder can select an emergency alert from the list of emergency alerts 1504 to be shown an emergency alert detail screen 1502 that displays emergency data 1505 associated with the emergency alert. For example, in the example illustrated by FIG. 15A, the first responder accessing the first responder application 1543C has selected emergency alert #1 (e.g., Alert #1) from the list of emergency alerts 1504 and is now shown an emergency alert detail screen 1502 that displays emergency data 1505 associated with emergency alert #1. In this example, emergency alert #1 is the same emergency alert generated by the vehicles telematics system in the example described with respect to FIG. 12. In this example, however, the RDC did not need to receive a dispatch request associated with the emergency alert and transmit an emergency data request to the ERDP to receive the emergency data associated with the emergency alert. Instead, the ERDP transmitted the emergency alert (and any emergency data associated with the emergency alert) to the RDC as soon as the ERDP received the emergency alert. In this example, the RDC received the location of the first responder accessing the first responder application 1543C on their first responder device 1551 (e.g., the RDC received a location generated by the first responder device 1551 through the first responder application 1543C), identified the first responder accessing the first responder application 1543C as within a predetermined radius of the emergency location associated with the emergency alert (as described above), and transmitted the emergency alert to the first responder accessing the first responder application 1543C. In this way, the first responder accessing the first responder application 1543C is notified of the auto incident represented by emergency alert #1 and receives emergency data associated with the auto incident sooner than they would have been had they needed to wait to receive a dispatch request associated with emergency alert #1. In some embodiments, the emergency alert detail screen 1502 includes a respond button 1507 that the first responder accessing the first responder application 1543C can select to identify themselves as responding (as described above) to the selected emergency alert. In some embodiments, when the RDC forwards or transmits an emergency alert to a first responder, the first responder is notified in one or more ways. For example, in some embodiments, when the RDC forwards or transmits an emergency alert to a first responder, the first responder is notified in the form of a text message, an email, or a push notification (e.g., from a first responder application). In some embodiments, as illustrated by FIG. 15B, after the RDC transmits an emergency alert to a first responder for display within a first responder application 1543C, if and when the RDC receives a dispatch request associated with the emergency alert and transmits the dispatch request to the first responder for display within the first responder application 1543C, the first responder application removes the emergency alert from the list of emergency alerts 1504 or replaces the emergency alert with a dispatch request within a list of dispatch requests 1503.

Digital Emergency Service Requests for Secondary ESPs

As described above, in various embodiments, the ERDP can generate and transmit a digital emergency service request (also referred to as a “digital primary request for emergency service”) to a primary ESP. In general, a digital emergency service request can convey information regarding an emergency (e.g., the identity of one or more persons experiencing the emergency, the location of the emergency, the nature of the emergency, etc.) faster and more accurately than a traditional emergency service request (e.g., an emergency call). A primary ESP can respond to a digital emergency service request similarly to the ways in which the primary ESP can respond to a traditional emergency service request, such as by assessing the nature and the severity of the emergency represented by the digital emergency service request and then transmitting a dispatch request regarding the digital emergency service request to one or more secondary ESPs, as described above. In some embodiments, as described in further detail below, when the ERDP generates a digital emergency service request, the ERDP can transmit the digital emergency service request (or a duplicate of the digital emergency service request) to a primary ESP and a secondary ESP simultaneously. By doing so, the ERDP enables the secondary ESP to prepare to respond to the emergency represented by the digital emergency service request before receiving a dispatch request the emergency from the primary ESP, which may allow the secondary ESP to respond to the emergency faster.

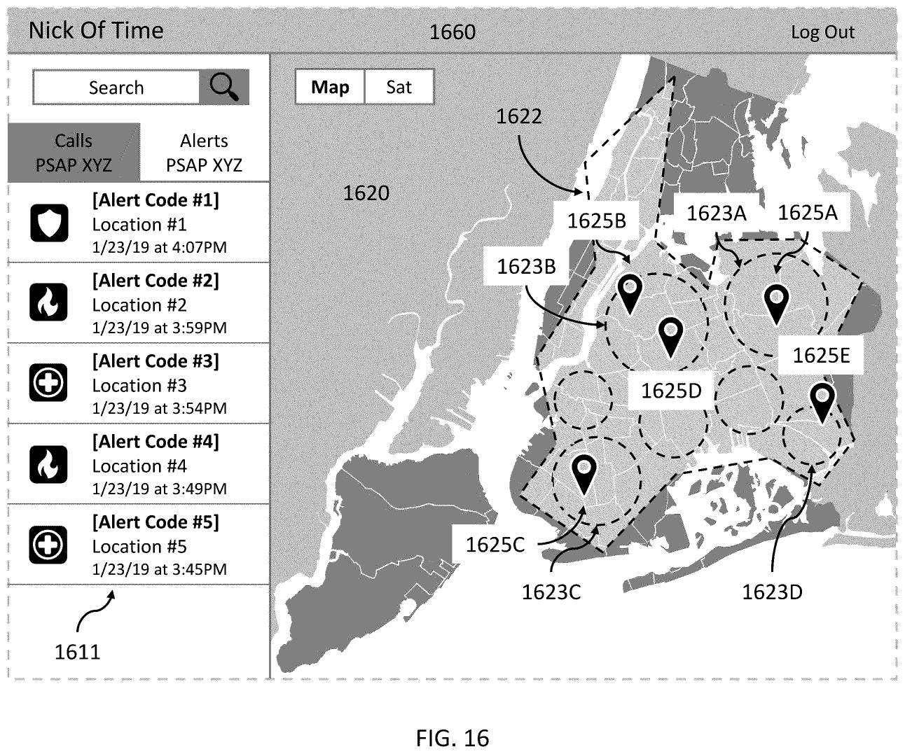

In some embodiments, the ERDP can simultaneously transmit a digital emergency service request to a primary ESP and a secondary ESP using a geofence system. For example, in some embodiments, when the ERDP receives an emergency alert that includes an emergency location, the ERDP can retrieve geofences associated with one or more primary ESPs and one or more secondary ESPs and determine if the emergency location falls within a geofence associated with a primary ESP (also referred to as a “primary ESP geofence”) and a geofence associated with a secondary ESP (also referred to as a “secondary ESP geofence”). If the emergency location falls within a primary ESP geofence and a secondary ESP geofence, the ERDP can generate a digital emergency service request for the emergency alert and transmit the digital emergency service request to both the primary ESP associated with the primary ESP geofence and the secondary ESP associated with the secondary ESP geofence. For example, FIG. 16 illustrates an exemplary embodiment of an emergency response application 1660 provided by the ERDP to a primary ESP. In the example illustrated by FIG. 16, PSAP XYZ (e.g., a primary ESP) has received five digital emergency service requests (e.g., Alert Code #1-Alert Code #5), which are now displayed within the list of digital emergency service requests 1611. Five respective alert locations 1625 (e.g., alert locations 1625A-1625D) are displayed within the interactive map 1620. As described above, the ERDP has transmitted the five digital emergency service requests to PSAP XYZ because the alert locations 1625 associated with the five digital emergency service requests fall within PSAP XYZ's jurisdiction, represented in FIG. 16 by primary ESP geofence 1622. In the example illustrated in FIG. 16, primary ESP geofence 1622 encompasses a plurality of secondary ESP geofences 1623 (e.g., secondary ESP geofences 1623A-1623D), and each of the five alert locations 1625 fall within both the primary ESP geofence 1622 and one of the secondary ESP geofences 1623. For example, alert location 1625A falls within both primary ESP geofence 1622 and secondary ESP geofence 1623A, alert locations 1625B and 1625D fall within both primary ESP geofence 1622 and secondary ESP geofence 1623B, alert location 1625C falls within both primary ESP geofence 1622 and secondary ESP geofence 1623C, and alert location 1625E falls within both primary ESP geofence 1622 and secondary ESP geofence 1623D. In this example, because alert location 1625A falls within both primary ESP geofence 1622 and secondary ESP geofence 1623A, the ERDP can transmit the digital emergency service request associated with alert location 1625A (e.g., Alert Code #1) to both PSAP XYZ and the secondary ESP associated with secondary ESP geofence 1623A simultaneously. Similarly, the digital emergency service requests associated with alert locations 1625B and 1625D (e.g., Alert Code #2 and Alert Code #4) can be simultaneously transmitted to both PSAP XYZ and the secondary ESP associated with secondary ESP geofence 1623B, the digital emergency service request associated with alert location 1625C (e.g., Alert Code #3) can be simultaneously transmitted to both PSAP XYZ and the secondary ESP associated with secondary ESP geofence 1623C, and the digital emergency service request associated with alert location 1625E (e.g., Alert Code #5) can be simultaneously transmitted to both PSAP XYZ and the secondary ESP associated with secondary ESP geofence 1623D. In some embodiments, a digital emergency service request is associated with an emergency type (e.g., fire, medical, police, etc.), and the ERDP only transmits the digital emergency service request to a secondary ESP if the secondary ESP is associated with the emergency type. For example, as illustrated in FIG. 16, both Alert Code #2 and Alert Code #4 are associated with a fire emergency type. In this example, while the alert locations associated with Alert Codes #2 and #4 fall within secondary ESP geofence 1623B, the ERDP will only transmit Alert Codes #2 and #4 to the secondary ESP associated with secondary ESP geofence 1623B if the secondary ESP is associated with fire emergencies (e.g., if the secondary ESP is a fire department, not a police department).

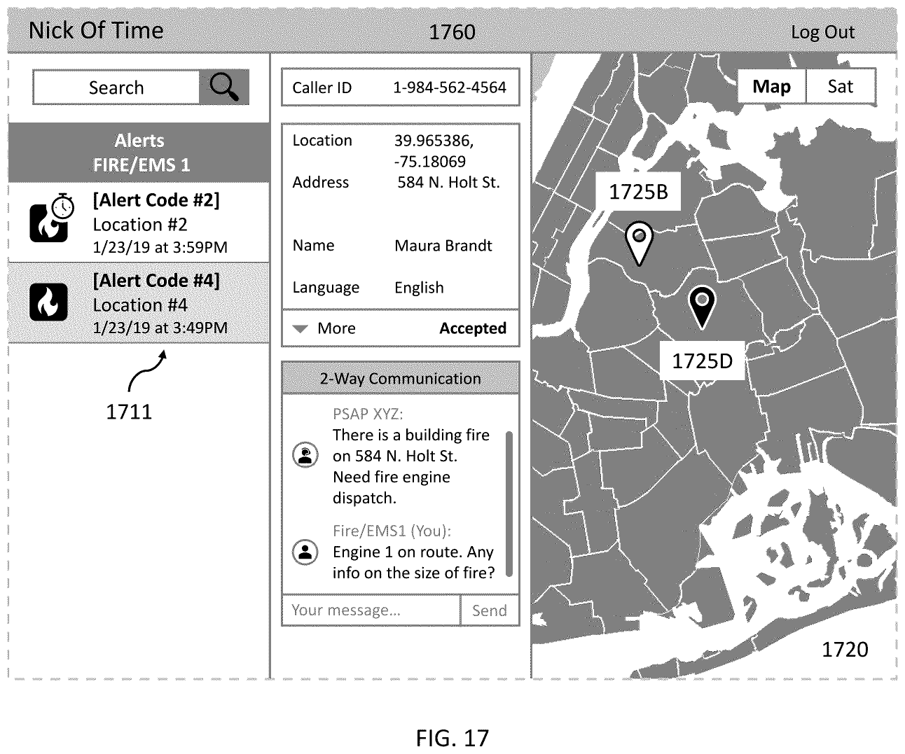

FIG. 17 illustrates an exemplary embodiment of an emergency response application provided by the ERDP to a secondary ESP. In the example illustrated by FIG. 17, emergency response application 1760 is accessed by FIRE/EMS 1, which is associated with secondary ESP geofence 1623B (as illustrated in FIG. 16). As described above with respect to FIG. 16, because alert locations 1625B and 1625D fell within both primary ESP geofence 1622 (associated with PSAP XYZ) and secondary ESP geofence 1623B, the ERDP was able to simultaneously transmit digital emergency service requests associated with alert locations 1625B and 1625D to both PSAP XYZ and FIRE/EMS 1 (e.g., through separate instances of the emergency response application provided to both ESPs). Emergency response application 1760 now displays the two digital emergency service requests (e.g., Alert Code #2 and Alert Code #4) within the list of digital emergency service requests 1711 and the alert locations associated with the two digital emergency service requests (e.g., alert locations 1725B and 1725D) within the interactive map 1720. In this example, a user of the emergency response application 1760 has selected Alert Code #4, which has prompted the emergency response application 1760 to display additional information regarding Alert Code #4. In some embodiments, as illustrated in FIG. 17, when the ERDP transmits a digital emergency service request to both a primary ESP and a secondary ESP, the ERDP can facilitate (e.g., through separate instances of the emergency response application provided to both ESPs) a two-way communication session (e.g., a text or voice communication session) between the two ESPs. In some embodiments, when the ERDP transmits a digital emergency service request to a secondary ESP, the digital emergency service request is initially presented within the graphical user interface (GUI) of the emergency response application 1760 in a pending state, and the digital emergency service request remains in a pending state until the ERDP receives an indication from the RDC that a dispatch request regarding the digital emergency service request has been made by a primary ESP. A digital emergency service request may be presented within the GUI of an emergency response application in a pending state in various ways. For example, in the example illustrated in FIG. 17, the emergency type icon displayed for Alert Code #2 is displayed with an additional stopwatch icon to indicate that Alert Code #2 is in a pending state. Similarly, to indicate that Alert Code #2 is in a pending state, the alert location associated with Alert Code #2 (e.g., alert location 1725B) is displayed within the interactive map 1720 in a color different to that of alert location 1725D, which is associated with a digital emergency service request that is not in a pending state (e.g., Alert Code #4). In contrast, in this example, because the RDC has received a dispatch request from a primary ESP (e.g., PSAP XYZ) including a user identifier (e.g., a phone number) associated with Alert Code #4 and transmitted an indication of receipt of the dispatch request to the ERDP, Alert Code #4 is no longer presented within the GUI of the emergency response application 1760 in a pending state.

In some embodiments, as described above, a secondary ESP is associated with one or more first responders. In some such embodiments, when the ERDP transmits a digital emergency service request to a secondary ESP, the ERDP can transmit emergency data associated with the digital emergency service request to the RDC, and the RDC can transmit the emergency data associated with the emergency service request to the one or more first responders associated with the secondary ESP (e.g., through a first responder application provided by the RDC to the one or more first responders, as illustrated in FIGS. 15A and 15B). In this way, because the ERDP and the RDC can deliver emergency data associated with a digital emergency service request to one or more first responders before the one or more first responders receive a dispatch notification regarding the emergency represented by the digital emergency service request (as described above), the one or more first responders are enabled to prepare for responding to the emergency earlier, which may allow the one or more first responders to respond to the emergency faster.

Responder Data Transmission to ESPs

As mentioned above, in various embodiments, an RDC can be integrated with or into an ERDP to provide emergency response assistance to ESPs. In some embodiments, the RDC can provide responder data (e.g., data regarding or generated by a first responder or the first responder's first responder device) to the ERDP. The ERDP can then provide the responder data to one or more ESPs. For example, in some embodiments, as depicted in FIGS. 11A and 11B, when an electronic device 1101 (e.g., a mobile phone) delivers a request for emergency service (e.g., by dialing 9-1-1 in the United States) to an ESP 1130 (e.g., a primary ESP, as described above), the electronic device 1101 also transmits an emergency alert to the ERDP (e.g., through the clearinghouse 1120, as described above). In some embodiments, as described above, the ERDP can then transmit the emergency alert (and any available emergency data associated with the emergency alert) to the ESP (as described above). In some embodiments, the ERDP transmits the emergency alert to the ESP through an emergency response application (as described above). In some embodiments, if the ERDP receives responder data (e.g., a responder identifier, a responder location, audio or video recorded by a responder device, notes or comments made a first responder, etc.) from the RDC that the ERDP can associate with the ESP or the emergency alert, the ERDP can transmit the responder data to the ESP as well (such as through the emergency response application).

In some embodiments, the RDC provides responder locations to the ERDP. For example, in some embodiments, the RDC provides every responder location received by the RDC (e.g., from a first responder application executed or otherwise accessed on a first responder device, as described above) to the ERDP. Or for example, in some embodiments, the RDC provides a responder location associated with a first responder to the ERDP only when the first responder identifies as responding to a dispatch request (e.g., by selecting a respond button within a dispatch request detail screen associated with the dispatch request within a GUI of a first responder application, as described above). In some embodiments, the RDC only receives a responder location associated with a first responder when the first responder identifies as responding to a dispatch request. In some embodiments, once a first responder identifies as responding to a dispatch request using a first responder application, the first responder application periodically gathers an updated responder location from the first responder device executing or accessing the first responder application and transmits the updated responder location to the RDC. The RDC can then transmit the updated responder location to the ERDP. In some embodiments, the RDC receives a responder location generated by a wearable device worn by a first responder. In some embodiments, when the RDC transmits a responder location associated with a first responder to the ERDP, the responder location includes, is tagged with, or is otherwise associated with a responder identifier associated with the first responder. A responder identifier may be any identifier associated with a first responder, including, but not limited to, a name, a username, a phone number, an email address, or a responder unit code. In some embodiments every first responder registered with the RDC (as described above) is associated with a unique responder identifier.

In some embodiments, the RDC provides additional data generated by a first responder or the first responder's first responder device to the ERDP. For example, in some embodiments, a first responder can generate or submit additional data to the RDC through a first responder application executed on or accessed on the first responder's first responder device (as described above). For example, in some embodiments, when responding to an emergency, a first responder can record audio or video of the emergency on their first responder device and transmit the recording to the RDC (e.g., through a first responder application). In some embodiments, a first responder can stream audio or video of an emergency to the RDC through a first responder application executed or accessed on their first responder device. After receiving a recording of audio or video from a first responder, the RDC can transmit the recording to the ERDP. Or for example, in some embodiments, a first responder can submit notes or comments regarding an emergency to the RDC. In some embodiments, when responding to an emergency, a first responder can generate or submit notes or comments regarding the emergency to the RDC through a first responder application executed or accessed on their first responder device. In some embodiments, when responding to an emergency, a first responder can email or text notes or comments regarding the emergency to the RDC. In some embodiments, additional data generated by a first responder or the first responder's first responder device and received by the RDC includes, is tagged with, or is otherwise associated with a responder identifier associated with the first responder (as described above).

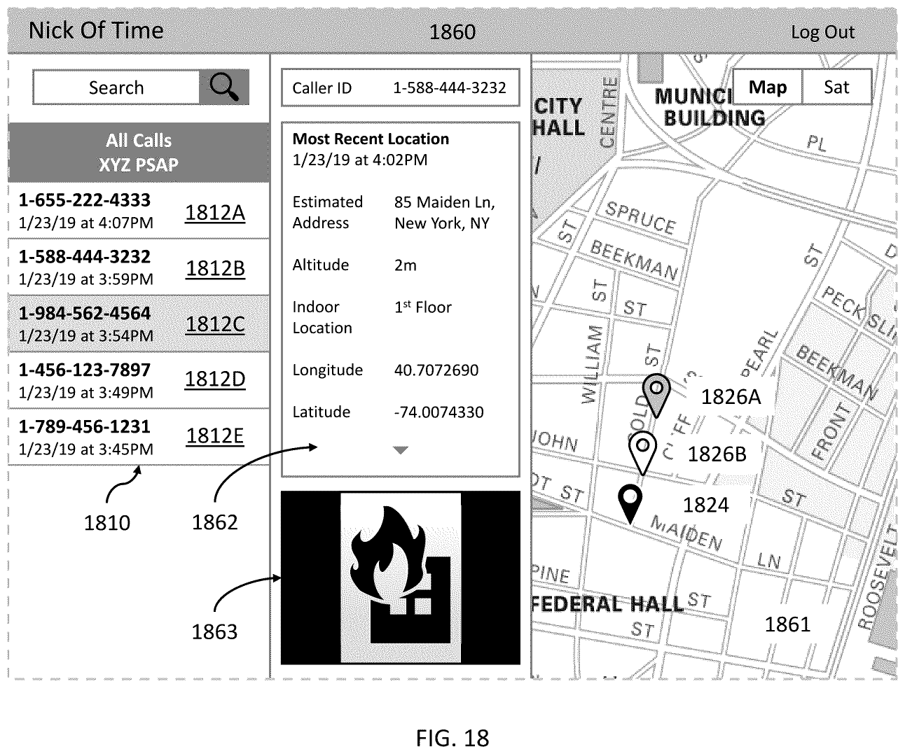

As mentioned above, in some embodiments, after receiving responder data from an RDC, the ERDP can transmit the responder data to an ESP. FIG. 18 illustrates an exemplary embodiment of responder data transmitted by an ERDP to an ESP and displayed within a graphical user interface (GUI) of an emergency response application. In some embodiments, as illustrated by FIG. 18, the GUI of an emergency response application 1860 includes a list of incidents 1810, an interactive map 1861, and a single incident card or section 1862. In some embodiments, as illustrated by FIG. 18, the list of incidents 1810 includes one or more incidents 1812 representing one or more respective requests for emergency service (e.g., emergency calls), as described above. In some embodiments, as illustrated by FIG. 18, the single incident card or section 1862 displays data (e.g., emergency data, responder data, etc.) associated with a particular incident 1812 selected from the list of incidents 1810. In some embodiments, as illustrated by FIG. 18, the interactive map 1861 displays locations (e.g., incident locations, responder locations, etc.) associated with the one or more incidents 1812. In the example illustrated by FIG. 18, incident 1812C represents a building fire emergency for which an emergency call was made and received by XYZ PSAP (e.g., a primary ESP accessing the emergency response application 1860). In this example, the mobile phone that made the emergency call also generated and transmitted an emergency alert including a user identifier (e.g., phone number 1-984-562-4564) and an emergency location. The ERDP has transmitted the emergency alert to XYZ PSAP (as described above). The user identifier is now displayed within the list of incidents 1810 as incident 1812C and the emergency location is now displayed within the interactive map 1861 as incident location 1824. In this example, XYZ PSAP has generated and transmitted a dispatch request, including the user identifier associated with the emergency call, for the building fire (as described above), and the dispatch request has been received and forwarded by the RDC to a fire department (e.g., a secondary ESP) and one or more firefighters (e.g., first responders) associated with the fire department. In this example, a firefighter has received the dispatch request through a first responder application accessed on the firefighter's mobile phone and identified themselves as responding to the dispatch request through the first responder application (as described above). The RDC has subsequently received the first responder's responder location from the first responder application and transmitted the responder location to the ERDP, which has transmitted the responder location to XYZ PSAP. XYZ PSAP selected incident 1812C from the list of incidents 1810, which prompted the emergency response application 1860 to display a single incident card 1862 for incident 1812C and display the responder location 1826A within the interactive map 1861. Two minutes later, the RDC received an updated responder location from the first responder application accessed on the firefighter's mobile and transmitted the updated responder location to the ERDP, which has transmitted the updated responder location to XYZ PSAP and displayed the updated responder location 1826B within the interactive map 1861. In this example, responder location 1826A (now a historic responder location) and updated responder location 1826B are displayed within the interactive map 1861 simultaneously. In this example, after arriving at the building fire, the firefighter records and transmits (e.g., streams) a video of the building fire through the first responder application accessed on the firefighter's mobile phone to the RDC. The RDC transmits the video to the ERDP, the ERDP transmits the video to XYZ PSAP through the emergency response application 1860, and the emergency response application 1860 now plays the video 1863 through the GUI of the emergency response application 1860.

Responder Multimedia Sharing

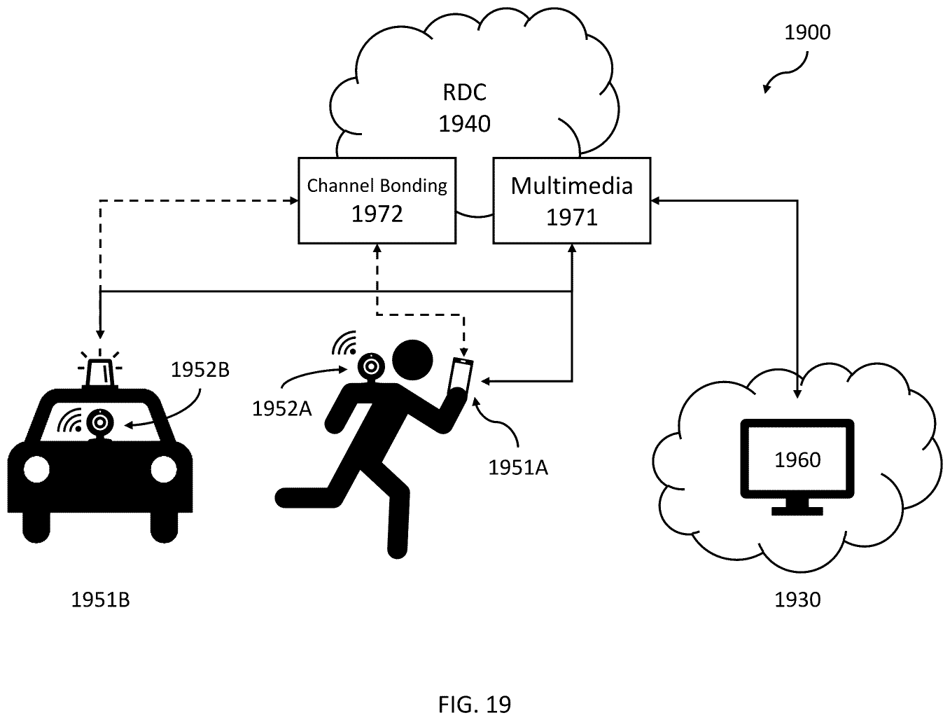

As mentioned above, in some embodiments, a responder dispatch coordination system (or an emergency response data platform (ERDP) that includes, or is otherwise communicatively coupled to, the responder dispatch coordination system (RDC)) can transmit multimedia captured or otherwise generated by a first responder to an emergency service provider (ESP). FIG. 19 depicts a system 1900 for sharing multimedia captured or otherwise generated by a first responder with an ESP. In some embodiments, as depicted in FIG. 19, the system 1900 includes an RDC 1940 (which may be included in, or communicatively coupled to, an ERDP, as described above), a responder device 1951, and an ESP 1930. In some embodiments, as depicted in FIG. 19, the system 1900 additionally or alternatively includes a multimedia capturing device 1952. In some embodiments, as depicted in FIG. 19, the system 1900 additionally or alternatively includes a multimedia processing server 1971 or a channel bonding server 1972 (either or both of which may be included in the RDC 1940 or an ERDP that the RDC 1940 is included in or communicatively coupled to). In various embodiments, the components of the system 1900 work cooperatively to capture or generate multimedia associated with an emergency being responded to by a first responder and transmit the multimedia to an ESP.

In some embodiments, when a first responder responds to an emergency (e.g., when a first responder receives a dispatch request through a first responder application accessed on the first responder's responder device, as described above), the first responder employs one or more multimedia capturing devices 1952. For example, in some embodiments, as depicted in FIG. 19, when a first responder (e.g., a police officer) responds to an emergency, the first responder wears a body camera 1952A that records multimedia (e.g., audio or video) of the first responder's response to the emergency. Body cameras worn by first responders while they respond to emergencies can assist emergency response efforts by providing additional situational awareness. Similarly, in some embodiments, as depicted in FIG. 19, when a first responder responds to an emergency, a vehicle employed by the first responder includes one or more multimedia capturing devices, such as dashboard camera 1952B. However, a multimedia capturing device 1952 may be any device capable of capturing or generating multimedia (e.g., photo or video) associated with an emergency being responded to by a first responder. For example, in some embodiments, a multimedia capturing device 1952 and a responder device 1951 are the same device (e.g., a mobile phone).

In some embodiments, a multimedia capturing device 1952 includes a network component (e.g., an antenna and associated components, Wi-Fi adapters, Bluetooth adapters, etc.) capable of connecting to one or more communication networks (e.g., a Wi-Fi network, a cellular network, or a satellite network) through which the multimedia capturing device 1952 can transmit multimedia captured or generated by the multimedia capturing device 1952 directly to the RDC 1940 (e.g., to a multimedia processing server 1971 included in or otherwise communicatively coupled to the RDC 1940). The RDC 1940 (or a multimedia processing server 1971 included in or otherwise communicatively coupled to the RDC 1940) can then transmit the multimedia captured or generated by the multimedia capturing device 1952 to one or more recipients, such as an ESP 1930. However, in some embodiments, a multimedia capturing device 1952 cannot connect to a communication network through which the multimedia capturing device 1952 can transmit multimedia directly to the RDC 1940. For example, in some embodiments, the network component of a multimedia capturing device 1952 can only connect to a Wi-Fi network (e.g., the network component does not have cellular connectivity). In such an embodiment, if there is no Wi-Fi network within range of the multimedia capturing device 1952, the multimedia capturing device 1952 cannot transmit multimedia directly to the RDC 1940.

In some embodiments, when a multimedia capturing device 1952 cannot connect to a communication network through which the multimedia capturing device 1952 can transmit multimedia directly to the RDC 1940, the multimedia capturing device 1952 can transmit multimedia to the RDC 1940 indirectly, such as by establishing a communication link with a second device that is able to transmit multimedia directly to the RDC 1940 (e.g., a responder device 1951 with cellular network connectivity). Because a multimedia capturing device 1952 with cellular network connectivity can be significantly more expensive than a multimedia capturing device 1952 without cellular network connectivity, indirectly transmitting multimedia from a multimedia capturing device 1952 to an RDC 1940 (e.g., through a communication link established between the multimedia capturing device 1952 and a responder device 1951 with cellular network connectivity) can be a more economical solution for first responders and first response agencies. In some embodiments, when a multimedia capturing device 1952 does not have cellular network connectivity, in order to indirectly transmit multimedia from a multimedia capturing device 1952 to an RDC 1940, the multimedia capturing device 1952 generates or otherwise provides a wireless access point (e.g., a hotspot) that other devices can connect to. Although the multimedia capturing device 1952 does not have cellular network connectivity, and thus cannot provide internet access to a device that connects to the wireless access point provided by the multimedia capturing device 1952, the multimedia capturing device 1952 can communicate with any device that connects to the wireless access point provided by the multimedia capturing device 1952. Thus, when a responder device 1951 connects to the wireless access point, the multimedia capturing device 1952 can transmit multimedia (e.g., a stream of multimedia) captured or generated by the multimedia capturing device 1952 to the responder device 1951 through a communication link established between the multimedia capturing device 1952 and the responder device 1951 through the wireless access point. The responder device 1951 can then transmit the multimedia (e.g., the stream of multimedia) to the RDC 1940 (or a multimedia processing server 1971 included in or otherwise communicatively coupled to the RDC 1940, as described below). Once the RDC 1940 (or a multimedia processing server 1971 included in or otherwise communicatively coupled to the RDC 1940) has received the multimedia (e.g., the stream of multimedia) from the responder device 1951, the RDC 1940 (or the multimedia processing server 1971) can then transmit the multimedia (e.g., the stream of multimedia) to an ESP (such as through an emergency response application executed on a computing device associated with the ESP, as described above).

For example, in the example depicted in FIG. 19, a mobile application (e.g., a responder application, as described above) executed on a responder device 1951A (e.g., a mobile phone) has received a dispatch request (as described above) from an ESP. In this example, a first responder associated with the responder device 1951A has indicated (e.g., through the responder application) that he is responding to the dispatch request. In this example, in response to the first responder indicating that he is responding to the dispatch request, the mobile application executed on the responder device 1951A has established a first communication link between the responder device 1951A and a multimedia capturing device 1952A (e.g., a body camera worn by the first responder) through a wireless access point provided by the multimedia capturing device 1952A (as described above) and a second communication link between the responder device 1951A and the RDC 1940 (or a multimedia processing server 1971 included in, provided by, or otherwise communicatively coupled to the RDC 1940) through a cellular communication network accessible by the responder device 1951A. In this example, after the first and second communication links are established, the multimedia capturing device 1952A begins transmitting multimedia (e.g., a stream of multimedia, such as a video stream) to the responder device 1951A. The mobile application receives the multimedia transmitted from the multimedia capturing device 1952A to the responder device 1951A through the first communication link and then transmits the multimedia to the RDC 1940 (e.g., to a multimedia processing server 1971 included in, provided by, or otherwise communicatively coupled to the RDC 1940) through the second communication link. The RDC 1940 (or the multimedia processing server 1971) can then transmit the multimedia to an ESP (e.g., the ESP that generated the dispatch request). In some embodiments, the multimedia capturing device 1952A transmits the multimedia to the responder device 1951A (e.g., to the mobile application executed on the responder device 1951A) through a first protocol, and the responder device 1951A (e.g., the mobile application executed on the responder device 1951A) transmits the multimedia to the RDC 1940 (or to a multimedia processing server 1971 associated with the RDC 1940) through a second protocol different from the first protocol. For example, in some embodiments, the multimedia capturing device 1952A transmits the multimedia to the responder device 1951A through the real-time streaming protocol (RTSP), and the responder device 1951A transmits the multimedia to the RDC 1940 through the real-time messaging protocol (RTMP). In some embodiments, the responder device 1951A (e.g., the mobile application executed on the responder device 1951A) transmits the multimedia to the RDC 1940 (or to a multimedia processing server 1971 associated with the RDC 1940) through a first protocol, and the RDC 1940 (or the multimedia processing server 1971) transmits the multimedia to an ESP through a second protocol different from the first protocol. For example, in some embodiments, the responder device 1951A transmits the multimedia to the RDC 1940 through the RTSP protocol or the RTMP protocol, and the RDC 1940 transmits the multimedia to an ESP through the web real-time communication protocol (WebRTC) or the HTTP live streaming protocol (HLS).

As described above, in some embodiments of the system 1900, a mobile application executed on a responder device 1951 establishes a first communication link with a multimedia capturing device 1952 through a wireless access point provided by the multimedia capturing device 1952 a second communication link with an RDC 1940 (or a multimedia processing server 1971 associated with the RDC 1940) through a cellular communication network. The mobile application can then receive multimedia (e.g., a stream of multimedia) from the multimedia capturing device 1952 through the first communication link and transmit the multimedia to the RDC 1940 through the second communication link. In some embodiments, as mentioned above, the system 1900 includes a channel bonding server 1972 configured to manage the reception of the stream of multimedia from the multimedia capturing device to the mobile application through the first communication link and the transmission of the stream of multimedia from the mobile application to the multimedia processing server through the second communication link. In general, channel bonding refers to the dynamic aggregation of two or more network connections (e.g., communication links) to enable additional or enhanced functionality (e.g., greater connectivity, throughput, speed, reliability, or redundancy) that the individual network connections could not otherwise provide. In some embodiments of the system 1900, even if the responder device 1951 has established more than one network connection (e.g., a first communication link established through a wireless access point provided by a multimedia capturing device 1952 and a second communication link established through a cellular communication network, as described above), the responder device 1951 only allows applications executed on the responder device 1951 to send and receive data through one network connection at a time (e.g., the responder device 1951 gives preference to a Wi-Fi connection over a cellular connection). In some such embodiments, the mobile application executed on the responder device 1951 can establish a third communication link with a channel bonding server 1972 (e.g., through the cellular communication network), and establish a virtual private network (VPN) with the channel bonding server 1972 through the third communication link. Through the VPN established by the mobile application executed on the responder device 1951, the channel bonding server 1972 can ensure that multimedia is received by the mobile application from the multimedia capturing device 1952 through the first communication link (i.e., the communication link established between the multimedia capturing device 1952 and the mobile application through the wireless access point provided by the multimedia capturing device 1952) and transmitted by the mobile application to the RDC 1940 through the second communication link (i.e., the communication link established between the mobile application and the RDC 1940 through the cellular communication network.

### EXAMPLES

The following illustrative examples are representative of embodiments of the invention(s) described herein and are not meant to be limiting in any way.

### Example 1

On My Way! is an emergency response company that aids emergency service providers (ESPs; e.g., public safety answering points, or “PSAPs”) and first responders alike by providing an emergency notification and response system that gathers emergency data and conveys that information directly to the emergency service providers and first responders.

Traditionally, when a PSAP receives a 911 call, a telecommunicator at the PSAP will analyze the situation and notify the appropriate emergency response agency. The emergency response agency (e.g., fire station, police station, emergency medical services (EMS); hereinafter, “secondary agency”) will select the first responders who will be responding to the emergency. If the secondary agency relies on volunteer responders, as seen in rural volunteer fire departments, the responders are often located remotely from the station and are on-call. In these instances, the on-call responders are given five minutes to confirm whether they are responding to the emergency. Within that time frame, a house fire can go from miniscule to catastrophic. On My Way! understands how critical it is to quickly notify responders and respond to a dispatch request as soon as possible.

To facilitate a quick notification and response procedure, On My Way! maintains and provides a web- and application-based tool that allows end users (i.e., first responders) to be notified of a dispatch request in one second or less. The PSAP will use a computer automated dispatch (CAD) system to send a dispatch request to the On My Way! system in the form of an email (SMTP or SNPP). The On My Way! website display screens will then display that dispatch request and notify the available responders. The method by which a responder is notified can consist of a text message, email, phone call, or push notification via the On My Way! app. The responder can select which method or methods they prefer, allowing for a redundancy in notifications. The responder has 30 seconds to respond to the dispatch notification before another notification is sent. Their response is then displayed on a screen located at the secondary agency where the secondary agency can view it. Compared to the traditional five-minute window, this faster response time can reduce unnecessary delay and allow for responders to get to the scene more quickly and efficiently.

On My Way! is also able to capture live audio via a Radio Dispatch Monitoring System (RDMS). Typically, when a dispatch request is sent from the PSAP, it is sent via two-way radio and emits a sound consisting of two differently pitched tones. RDMS is able to listen for the two tones and begin recording the audio from the dispatch request made by the PSAP. The audio is captured directly by the On My Way! servers from a user's computer where the RDMS software is downloaded. When the audio recording is complete, the On My Way! system will alert the responders via the On My Way! app that the recording is available, where they can then stream the audio from the server. In addition to app notifications, responders are also able to receive a hyperlink to the recording via text message or email.

Ariana, the administrator of a PSAP, learns of the ways in which On My Way! aids emergency response and joins the over 9,000 agencies who rely on On My Way!. On My Way! assigns her agency a unique email address so that when a dispatch request is sent to the On My Way! system, it is identifiable as sent from Ariana's PSAP. Bailey, a fire chief in Ariana's jurisdiction, uses her administrative log-in to create profiles for each firefighter under that jurisdiction and a member identification number is generated and linked to her agency. Her agency is able to use On My Way!'s interactive map to place markers indicating the location of vital information, including fire hydrants, gas stations, and automated external defibrillators (AEDs). In addition, the On My Way! display screen at the fire department allows Bailey to see responder information, including who is on duty, their position, and when they are on duty until. Each agency and responder is given the option to fully customize their display screen so it can be configured to meet their information and stylistic preferences. Cat, who is a volunteer firefighter for Bailey's agency, lives outside of the range of her department's radio dispatch and is often unable to receive dispatch requests via her two-way radio. Fortunately, Cat's department employs On My Way!'s technology, which allows her to receive notifications on her cell phone, no matter her location.

One day, a fire alarm is triggered in an apartment downtown and Ariana's PSAP receives several emergency calls. Ariana is able to quickly dispatch Bailey's fire department via the On My Way! system by emailing a dispatch request to On My Way! and sending out a dispatch request over the radio. In response, On My Way! sends dispatch notifications to all on-duty firefighters within Ariana's PSAP's jurisdiction. When Cat receives the push notification from the On My Way! app about the fire, she is able to quickly indicate that she will be responding and can obtain vital information from sensor data, including the time when the smoke alarms were triggered. Cat is concerned because the address of the fire is located in a densely populated area. She is able to use the On My Way! app to make a plan on how best to approach the fire, including viewing nearby fire hydrants, fire extinguishers, or buildings in close proximity, as well as determining the number of people who live in the building. This address looks very similar to Cat's friend's apartment and Cat wants to receive more information. Thanks to RDMS, she is easily able to listen to the recording of the dispatch request made over the radio via the On My Way! app and confirm the location of the fire, as well as how many people need help in the building. When Cat arrives at the fire, she already has a plan in place and is able to quickly and efficiently respond to the emergency. Since saving a few minutes can mean the difference between life or death, Cat, as well as the people in the emergency, are grateful for the life saving features provided by On My Way!.

### Example 2

Just In Time, an emergency response company, aids public safety services (such as public safety answering points, or “PSAPs”) by gathering data related to emergencies from a variety of sources and delivering the data directly to the public safety services through digital services and applications. In one example of Just In Time's technologies, Just In Time maintains and provides an Emergency Clearinghouse (hereinafter, “clearinghouse”) that receives and stores data and information from a plurality of sources, such as mobile phone and mobile applications, internet of things (IoT) devices, intelligent vehicle systems, and other electronic devices. During an emergency, the clearinghouse can gather information stored within or received by the clearinghouse regarding the emergency and deliver the information to PSAPs. In order to provide access to the information stored within or otherwise accessible to the clearinghouse to PSAPs as quickly and easily as possible, Just In Time develops and provides an emergency response application, Nick Of Time, in the form of a website accessible via a standard web browser. To further aid public safety services, Just In Time integrates their clearinghouse with the On My Way! system described in Example 1, so that Just In Time can provide data from the clearinghouse to On My Way! (and, by extension, the first responders that On My Way! supports) and so that On My Way! can provide data from first responders to Just In Time (and, by extension, the public safety services that Just In Time supports).

A PSAP in San Jose, California regularly employs Nick Of Time on the PSAP's computing devices. When a man on a hike outside of San Jose (but still within the jurisdiction of the San Jose PSAP) feels a pain in his chest, the hiker calls 9-1-1 on his mobile phone but collapses before the emergency call is answered by Jacob, a telecommunicator at the San Jose PSAP. Jacob can hear the sounds of the hiker struggling but is not able to communicate with the hiker. However, when the emergency call was made by the hiker's mobile phone, the mobile phone also generated and transmitted an emergency alert including the hiker's phone number and location (generated by the hiker's mobile phone) to Just In Time. Communicatively coupled to the hiker's smartwatch, the hiker's mobile phone also begins transmitting heartrate data generated by the hiker's smartwatch to Just In Time as well. In addition, the hiker has previously submitted information including his medical conditions within a medial ID app on the hiker's phone, and the medical ID app information is transmitted by the hiker's mobile phone to Just In Time as well. Although Jacob cannot communicate with the hiker directly, Just In Time uses the hiker's location to determine that the hiker is within the jurisdiction of Jacob's PSAP and automatically transmits the hiker's phone number and location, the heartrate data generated by the hiker's phone, and the hiker's medical ID app information to the San Jose PSAP through an instance of Nick Of Time being accessed on Jacob's PSAP computer. With this information, Jacob is able to quickly determine that the hiker may be having a cardiac emergency and sends out a dispatch request for the hiker to emergency medical personnel within the jurisdiction of the San Jose PSAP. In the dispatch request, Jacob is able to include the hiker's name and location (received from Just In Time) and an indication that the emergency may be a cardiac emergency. Jacob's dispatch request is received by On My Way! and then transmitted by On My Way! to all of the emergency medical personnel registered with On My Way! and servicing the jurisdiction of the San Jose PSAP.

Sarah, a volunteer EMT in San Jose, receives a dispatch notification regarding Jacob's dispatch request from On My Way! in three ways—as a text message, as an email, and as a push notification from the On My Way! mobile application installed on Sarah's mobile phone. Sarah clicks on the push notification to open the On My Way! mobile application and see details regarding Jacob's dispatch request. Within the On My Way! mobile application, Sarah sees the location of the hiker and that the hiker may be having a cardiac emergency. Sarah happens to be close to the location of the hiker and immediately selects a button within the On My Way! mobile application to identify herself as responding to Jacob's dispatch request. Then she begins driving to the hiker's location. When Sarah identifies herself as responding to Jacob's dispatch request, the On My Way! system transmits Sarah's phone number and location to Just In Time, which then transmits Sarah's phone number and location to the San Jose PSAP through the instance of Nick Of Time being accessed on Jacob's PSAP computer, where Jacob can see Sarah's location in real-time as she drives toward the hiker's location. In addition, Just In Time returns the hiker's medical ID app information to the On My Way! system, which transmits and displays the medical ID app information within Sarah's On My Way! mobile application, providing Sarah with even more situational awareness. Still on the emergency call with the hiker, Jacob is able to tell the hiker that a first responder is on the way and exactly the direction that the first responder is coming from. The hiker manages to tell Jacob that the hiker has injured his ankle as well. Through Nick Of Time, Jacob is able to send a message to Sarah saying that the hiker has also injured his ankle, and Sarah receives the message through the On My Way! mobile application. This is a level of visibility and communication with a volunteer first responder that Jacob would never have had before the integration of the On My Way! and Just In Time systems.

What is claimed:

1. A responder dispatch coordination system (RDC) comprising a memory, a network component, and at least one processor, wherein the RDC is communicatively coupled to an emergency data source and a plurality of responder devices and wherein the at least one processor is configured to:
receive, from an emergency service provider (ESP), a dispatch request comprising a user identifier associated with an electronic device;
transmit, to the emergency data source, an emergency data request comprising the user identifier;
receive, from the emergency data source, emergency data comprising an emergency location associated with the user identifier; and
transmit, to a responder device from the plurality of responder devices, the emergency data comprising the emergency location for display within a graphical user interface (GUI) of the responder device.

2. The system of claim 1, wherein the user identifier is associated with an emergency call routed to the ESP.

3. The system of claim 1, wherein the at least one processor is further configured to generate a dispatch notification for the dispatch request and transmit the dispatch notification to the responder device.

4. The system of claim 3, wherein the at least one processor is further configured to detect a selection of the dispatch notification from within the GUI of the responder device and transmit the emergency data to the responder device in response to detecting the selection of the dispatch notification.

5. The system of claim 1, wherein the at least one processor is further configured to extract the user identifier from the dispatch request.

6. The system of claim 5, wherein the at least one processor is further configured to receive the dispatch request from the ESP in a form of an email and extract the user identifier from contents of the email.

7. The system of claim 5, wherein the RDC is further configured to receive the dispatch request from the ESP in a form of an audio message over a radio signal and extract the user identifier from the audio message.

8. The system of claim 7, wherein the at least one processor is further configured to transcribe the audio message and transmit a transcription of the audio message to the responder device.

9. The system of claim 7, wherein the at least one processor is further configured to record the audio message and provide access to the audio message to the responder device.

10. The system of claim 1, wherein the at least one processor is further configured to provide a first responder application to the responder device and transmit the emergency data comprising the emergency location to the responder device through the first responder application.

11. The system of claim 10, wherein the emergency data source is an emergency response data platform (ERDP) communicatively coupled to the ESP and wherein the at least one processor is further configured to:
receive, from the first responder application, a selection of a dispatch notification generated for the dispatch request from within a GUI of the first responder application;
receive, from the first responder application, a responder identifier associated with the responder device and a responder location associated with the responder identifier; and
transmit, to the ERDP, the responder identifier and the responder location for transmission to the ESP.

12. The system of claim 11, wherein the responder identifier and the responder location are transmitted to the ESP through an emergency response application provided to the ESP by the ERDP.

13. The system of claim 12, wherein the emergency response application comprises a second graphical user interface comprising an interactive map and wherein the responder location is displayed within the interactive map.

14. The system of claim 11, wherein the responder location is generated by the responder device.

15. The system of claim 11, wherein the at least one processor is further configured to receive, from the first responder application, an audio or video recording and transmit the audio or video recording to the ERDP for transmission to the ESP.

16. The system of claim 15, wherein the audio or video recording is captured by the responder device.

17. The system of claim 1, wherein the at least one processor is further configured to:
transmit a second emergency data request comprising the user identifier to a second emergency data source;
receive, from the second emergency data source, second emergency data comprising personal data or medical data associated with the user identifier; and
transmit, to the responder device, the second emergency data for display within the GUI of the responder device.

18. The system of claim 1, wherein the ESP is functioning as a primary ESP for answering an emergency call or text.

19. The system of claim 1, wherein the ESP is a secondary ESP.

20. A method for sharing emergency data with a first responder, the method comprising:
receiving, from an emergency service provider (ESP), a dispatch request comprising a user identifier associated with an electronic device;
transmitting, to an emergency data source, an emergency data request comprising the user identifier;
receiving, from the emergency data source, emergency data comprising an emergency location associated with the user identifier; and
transmitting, to a responder device from a plurality of responder devices, the emergency data comprising the emergency location for display within a graphical user interface (GUI) of the responder device.
